(19) United States
(12) Patent Application Publication
(10) Pub. No.: US 2017/0223989 A1
(43) Pub. Date: Aug. 10, 2017

(54) DEFLAVORED EGG PROTEIN ISOLATE, PRODUCTS MADE WITH PROTEIN ISOLATES AND METHODS OF MAKING SAME

(71) Applicant: Rembrandt Enterprises, Inc., Spirit Lake, IA (US)

(72) Inventors: Jihan Cepeda Jimenez, Spirit Lake, IA (US); Mindi McKibbin, Spirit Lake, IA (US)

(21) Appl. No.: 15/403,921

(22) Filed: Jan. 11, 2017

Related U.S. Application Data
(60) Provisional application No. 62/291,811, filed on Feb. 5, 2016.
(60) Provisional application No. 62/342,588, filed on May 27, 2016.

(51) Int. Cl. A23L 2/66; A23J 1/08; A23L 2/68

(52) U.S. Cl. CPC A23L 2/66; A23L 2/68; A23J 1/08; A23V 2002/00

(57) ABSTRACT

This application relates generally to the processing of egg protein isolates for use in various food, sports nutrition and nutraceutical applications, methods of making egg protein isolates, and apparatus for making egg protein isolates. More particularly, the application relates to a method of deflavoring egg products and concentrating the protein content to greater than or equal to 92% dry basis protein. Deashing technologies can be used to produce egg protein isolates which can give egg additional tools to compete in the sports and nutrition markets dominated by whey and milk protein isolates.

### CLAIM OF PRIORITY

This application claims the benefit of U.S. Provisional Application No. 62/291,811, filed Feb. 5, 2016 and U.S. Provisional Application No. 62/342,588, filed May 27, 2016, the contents of which are herein incorporated by reference in their entirety.

### FIELD OF THE INVENTION

The present application is directed to egg protein isolates, compositions containing egg protein isolates, and methods of making egg protein isolates.

BACKGROUND

Protein is one of the key ingredients of any balanced diet. It is responsible for building muscle and many other tissues, and as such protein consumption is closely tied to muscular health and overall fitness.

In recent years, various protein compositions have become common dietary supplements. For example, whey protein is sold in a dried form for addition to various food compositions, such as fruit smoothies that contain blended fruit, water or ice, and dried whey protein. Soy protein is often also added. Egg proteins are also often added to many food compositions, such as with whole eggs in baked goods or separated egg yolk or egg albumen (also known as egg white) in mayonnaises, sauces or dressings and bakery or meat applications, respectively. Whole egg, as well as egg albumen, are known as being particularly desirable protein sources because they provide high levels of a wide variety of key essential amino acids. Also, egg proteins do not contain some of the drawbacks of various other protein sources, such as whey protein, which can contain at least some level of lactose that is not readily digested by people with lactose intolerance.

Unfortunately, egg protein has significant challenges to its incorporation into some food items. For example, existing egg products often readily gel upon heating, such as during traditional beverage or dairy pasteurization (ultra-high temperature, or “UHT”, pasteurization, for example). This gelling makes traditional egg products unsuitable for many applications, such as sports drinks where relatively low viscosity is desired. Also, egg products are characterized for being rich in sulfur and minerals that often provide an off-flavor to certain food items, such as beverages, that is not desirable.

Therefore, a need exists for improved egg proteins, in particular egg protein compositions that can be added to a variety of food products without the limitations and downsides of current egg products.

### SUMMARY

This application relates generally to the processing of egg protein isolates, from mixtures containing whole egg, egg white, and/or egg yolk, for use in various food, sports nutrition and nutraceutical applications. More particularly, the application relates to methods and apparatuses for deflavoring egg products and concentrating the protein content to elevated levels, such as to greater than or equal to 92% dry basis protein.

The methods involve, in example embodiments, processing high-protein egg product to retain the egg proteins while removing minerals and glucose naturally present in egg. Removing minerals is referred to herein as “deashing”. This deashing process improves the final egg product's flavor and provides other benefits. Deflavored egg protein isolate has less egg flavor, is less salty, and is more bland than dried egg. The deflavoring also, unexpectedly, can result in a perceived increase in sweetness of compositions made from the egg protein isolate. When the starting material contains whole egg or egg yolk a defatting step is recommended prior to deashing.

In some implementations, the method includes processing the egg product using ultrafiltration (UF) or nanofiltration (NF) technologies. In example implementations, deashing removes 45 to 100% of minerals. In alternative examples, deashing removes 50 to 80% of minerals. In some examples, the deashing removes greater than 45% or greater than 50% of minerals. In some examples, deashing removes less than 100% or less than 80% of minerals.

This application relates generally to the processing of egg protein isolates, including egg white protein isolates, for use in various food, sports nutrition and nutraceutical applications. More particularly, the application relates to a method of deflavoring egg products and concentrating the protein content to greater than or equal to 92% dry basis protein.

In certain implementations, the method comprises providing a starting material rich in egg protein such as liquid egg white; deashing the egg protein; concentrating the egg protein; and desugaring the egg protein. Optionally, the starting material may consist of mixtures of egg whites, whole egg, and/or egg yolk. Alternatively, the defatted egg protein material described on US 2015/0094453 A1 can be used as starting material (as described in FIG. 24, the Permeate 2450 could be utilized as a starting material).

In some embodiments, the deashing is accomplished using a nanofiltration or ultrafiltration membrane. The deashing can be accomplished by separation of the minerals from the albumen using a membrane of, for example, 300 to 10,000 daltons (Da). Optionally the deashing is accomplished by separation of the minerals and sugars from the albumen using a membrane of greater than 3,000 Da, such as 3,000 to 10,000 Da. In some embodiments, deashing is accomplished by separation of the minerals from the albumen using a membrane of 1,000 to 5,000 Da. Typically, the deashing is accomplished at a pressure less than 600 psi, desirably less than 300 psi, and more desirable less than 100 psi. In some implementations, the deashing and desugaring are simultaneous.

Generally desugaring comprises filtration, but can also or in the alternative comprise fermentation, such as yeast fermentation, or enzymatic reactions with enzymes like glucose oxidase.

The desugaring and deashing can include diafiltration, including diafiltration wherein 2 to 6 diafiltration volumes are used, desirably 4 to 6 diafiltration volumes. The diafiltration can be continuous or discontinuous. Typically, diafiltration reduces the mineral content of the albumen by at least 50%. In some constructions diafiltration reduces the mineral content of the albumen by at least 60%. Alternatively, diafiltration reduces the mineral content of the albumen by at least 70%. The resulting egg protein product has, in some implementations, an ash content below 3%, optionally less than 2%, and a gel strength of less than 200 g, optionally less than 150 g, and frequently with low elasticity.

Desirably the deflavored egg protein isolate has a color differentiation of greater than 6 in a 10% solution when compared to reconstituted dried egg, wherein color differential is measured by

ΔE*_{ab}=\sqrt{(L*₂−L*₁)²+(a*₂−a*₁)²+(b*₂−b*₁)²}

Color differentiation of greater than 6 is desirable for final beverage applications as it indicates minimal impact to the final beverage color (reducing yellowness often seen from proteins).

The application is also directed to a beverage containing an egg protein isolate.

The application is also directed to an egg albumen isolate having reduced foaming properties characterized by no whippability and/or excessive whip density values greater than 0.15 g/cm³ with low foam stability, and greater than 50% foam reduction after 60 minutes.

The application is also directed to a high acidity protein beverage with at least 3.5% protein and a pH of less than 4.0 which is hot fill pasteurized. Generally, the high acidity protein beverage is produced without elevated gelling as a result of the pasteurization, despite the egg content.

In an example implementation, the protein isolate has a whip density of greater than 0.15 g/cm³ with low foam stability with more than 50% foam reduction after 60 minutes. The protein isolate can have a reconstituted liquid color of L* greater than 40, optionally greater than 50. The protein isolate has a b* value of less than 15, optionally less than 10 in a 10% solution, and heat stability of ultra-high temperature (UHT), high temperature/short time (HTST) or hot fill beverage processing at protein concentrations of 0 to 8% w/w.

Protein bars made in accordance with the disclosure can have a browning characteristic of reduced Maillard browning over shelf-life. Baked goods made in accordance with the disclosure have similar textural properties to dried egg, such as dried egg whites. Protein fortification of baked goods made in accordance with the teachings herein have acceptable sensory characteristics at protein concentrations up to 2 times standard baked goods.

The method involves processing an egg protein material comprising egg white, whole egg, and/or egg yolk to retain the egg proteins while removing minerals and glucose naturally present in egg. Removing minerals is referred to herein as “deashing.” This deashing process improves the final egg product's flavor. Deflavored egg protein isolate has less egg flavor, is less salty, and is more bland than dried egg.

Higher levels of deashing may be achieved if ultra filtration/nanofiltration is performed with diafiltration. The diafiltration may be either continuous diafiltration (constant volume diafiltration) or discontinuous diafiltration. In some examples, the method is performed with less than 10 diafiltration volumes, optionally between 0.5 to 7 diafiltration volumes. In some examples, the method is performed between 4-6 diafiltration volumes.

In addition, the product may be pH adjusted and homogenized during processing prior to drying to optimize solubility, gelling, heat stability, or other characteristics in final food products such as beverages.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE DRAWINGS

Aspects may be more completely understood in connection with the following figures, in which:

FIG. 1 is a flow diagram of a process for making deflavored egg white (albumen) protein isolate.

FIG. 2 is a schematic illustration of membrane filtration and approximated molecular weight cutoff (MWCO).

FIG. 3 is a table showing major proteins in egg whites.

FIG. 4 is a table showing test parameters for spiral wound nanofiltration/ultrafiltration membranes.

FIG. 5 is a table showing processing scenarios for various examples of the disclosed technology.

FIG. 6 is a table showing deashing level and protein content achieved for the processing scenarios of FIG. 5.

FIG. 7 is a table showing powder and liquid color of the product achieved in the processing scenarios of FIG. 5.

FIG. 8 is a photographic comparison of dried egg white and the egg white protein isolate product produced using the disclosed technology.

FIG. 9 is a photographic comparison of solution containing dried egg white and solution containing the egg white protein isolate product produced using the disclosed technology.

FIG. 10A is a table showing an analysis of the resulting egg white protein isolate product produced using the processing scenarios 1-8 of FIG. 5.

FIG. 10B is a table showing an analysis of the resulting egg white protein isolate product produced using the processing scenarios 9-21 of FIG. 5.

FIG. 11A is a table showing the effect of heat treatment prior to drying on protein denaturation/coagulation.

FIG. 11B is a table showing the effect of heat treatment prior to drying on protein denaturation/coagulation.

FIG. 12 is a photograph showing experimental results of heat stability testing on the disclosed egg white protein isolate.

FIG. 13 is a table showing nutritional differences between a beverage mix made with egg whites vs. a beverage mix made with egg white protein isolate of the disclosed technology.

FIG. 14A is a table showing the nutritional content of a high acid ready-to-drink protein beverage formulated with egg white protein isolate of the disclosed technology.

FIG. 14B is a table showing the viscosity of the beverage of FIG. 14A.

FIG. 14C shows viscosities of protein solutions with pH adjustment.

FIG. 14D shows viscosities of protein solutions without pH adjustment.

FIG. 15 is a photographic comparison of a high acid beverage formulated with egg white protein isolate of the disclosed technology, before and after pasteurization.

FIG. 16 is a table showing experimental formulations of yellow cake made with dried egg white or egg white protein isolate of the disclosed technology.

FIG. 17A shows the measurement of cake heights according to AACC 10-91.01.

FIG. 17B shows the cake cutting pattern used to obtain samples for texture analysis by Rhodia Corp & Texture Technologies Corp., USA.

FIG. 18 is a table showing photographic images and quantitative differences between the experimental results of formulations of yellow cake according to FIG. 16.

FIG. 19 shows photographic images of various baked goods made with dried egg white or with egg white protein isolate of the disclosed technology.

FIG. 20 is a table showing ingredients used in experimental nutrition bars formulated with dried egg whites and egg white protein isolate of the disclosed technology.

FIG. 21 is a photographic image comparing a nutrition bar made with dried egg whites and a nutrition bar made with egg white protein isolate of the disclosed technology.

FIG. 22 is a spider chart (radar chart) showing a qualitative comparison of flavor profiles of dried egg white and egg white protein isolate of the disclosed technology.

FIG. 23 is a spider chart (radar chart) showing a qualitative comparison of flavor profiles of milk, whey, and soy protein isolate compared to egg white protein isolate of the disclosed technology.

FIG. 24 is a flow chart showing an implementation of the egg protein isolate of the disclosed technology using a starting mixture of egg white and egg yolk.

FIG. 25 is a table showing typical egg yolk composition.

FIG. 26 is a table showing amino acid compositions for various egg compositions and isolates.

FIG. 27 is a table showing amino acid compositions for various egg compositions and isolates.

While embodiments are susceptible to various modifications and alternative forms, specifics thereof have been shown by way of example and drawings, and will be described in detail. It should be understood, however, that the scope herein is not limited to the embodiments described. On the contrary, the intention is to cover modifications, equivalents, and alternatives falling within the spirit and scope herein.

### DETAILED DESCRIPTION

This application relates generally to the processing of mixtures containing egg white, whole egg, and/or egg yolk to produce egg protein isolates for use in various food, sports nutrition and nutraceutical applications. More particularly, the application relates to a method of deflavoring egg products, especially egg products with significant levels of egg white protein, and concentrating the egg protein content, such as to a level of greater than or equal to 92% dry basis protein.

The method involves processing an egg protein material comprising egg white, whole egg, and/or egg yolk to retain the egg proteins while removing minerals and glucose naturally present in egg. Removing minerals is referred to herein as “deashing.” This deashing process improves the final egg product's flavor. Deflavored egg protein isolate has less egg flavor, is less salty, and is more bland than dried egg.

In some implementations, the method includes processing the egg product using ultrafiltration (UF) or nanofiltration (NF) technologies. In some implementations, deashing removes 45-100% of minerals. In alternative examples, deashing removes 50-80% of minerals. In some examples, the deashing removes greater than 45% or greater than 50% of minerals. In some examples, deashing removes less than 100% or less than 80% of minerals.

This application relates generally to the processing of egg protein isolates for use in various food, sports nutrition and nutraceutical applications. More particularly, the application relates to a method of deflavoring egg products and concentrating the protein content to greater than or equal to 92% dry basis protein.

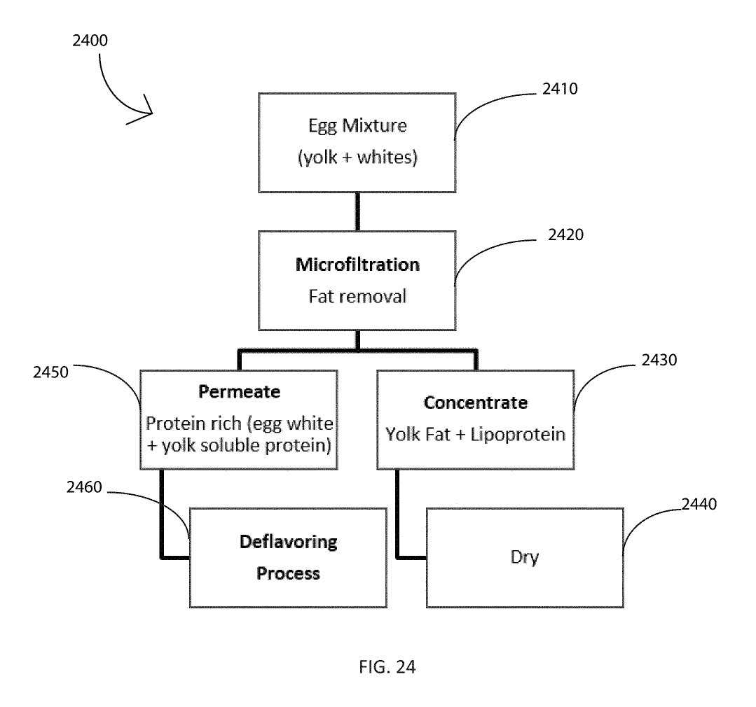

In certain implementations, the method comprises providing a starting material rich in egg protein such as liquid egg white; deashing the egg protein; concentrating the egg protein; and desugaring the egg protein. Optionally, the starting material may comprise a mixture of egg whites, whole egg, and/or egg yolk, which is deashed, concentrated, and desugared. In the case where egg yolk is present, then a defatted step is undertaken first. For example, the defatted egg protein material described in US 2015/0094453A1 can be used as starting material as referenced in FIG. 24, Permeate 2450. In some embodiments, the deashing is accomplished using a nanofiltration or ultrafiltration membrane. The deashing can be accomplished by separation of the minerals from the albumen using a membrane of 300 to 1,000 Da. Optionally the deashing is accomplished by separation of the minerals from the albumen using a membrane of greater than 3,000 Da. In some embodiments, deashing is accomplished by separation of the minerals from the albumen using a membrane of 3,000 to 5,000 Da. Typically, the deashing is accomplished at a pressure less than 600 psi, generally less than 300 psi, and desirably less than 100 psi.

Generally desugaring comprises filtration, but can also or in the alternative comprise fermentation, such as yeast fermentation.

The deflavoring and deashing can include diafiltration, including diafiltration wherein 2 to 6 diafiltration volumes are used, preferably 4 to 6 diafiltration volumes. The diafiltration can be continuous or discontinuous. Typically, diafiltration reduces the mineral content of the albumen by at least 50%. In some constructions diafiltration reduces the mineral content of the albumen by at least 60%. Alternatively, diafiltration reduces the mineral content of the albumen by at least 70%.

The resulting egg protein product has, in some implementations, an ash content below 3%, optionally <2% and a gel strength of less than 200 g, optionally <150 g with low elasticity.

Desirably the deflavored egg protein isolate has a color differentiation of greater than 6 in a 10% solution when compared to dried egg white, wherein color differential is measured by

ΔE*_{ab}=\sqrt{(L*₂−L*₁)²+(a*₂−a*₁)²+(b*₂−b*₁)²}

Color differentiation of greater than 6 is desirable for final beverage applications as it indicates minimal impact to the final beverage color (reducing yellowness often seen from proteins).

The application is also directed to a beverage containing egg protein isolate.

The application is also directed to an egg albumen isolate having a foaming property of greater or equal to 0.15 g/cm³ (a low foaming value) with low foam stability, optionally greater or equal to 50% foam reduction after 60 minutes.

The application is also directed to a high acidity beverage with at least 3.5% egg protein; pH of less than 4.0 which is hot fill pasteurized. The protein isolate has a whip density of greater than 0.15 g/cm³ with low foam stability (greater than 50% foam reduction after 60 minutes; a reconstituted liquid color of L*>40, optionally >50 and a b* value of greater than 15, optionally greater than 10 in a 10% solution; and heat stability of UHT, HTST or hot fill beverage processing at protein concentrations of 0 to 8% w/w.

Protein bars made which include this egg protein isolate have a browning characteristic of reduced Maillard browning over shelf-life. Baked goods made which include this egg protein isolate have similar textural properties to dried egg whites. Protein fortification of baked goods made which include this egg protein isolate have acceptable sensory characteristics at egg protein concentrations up to twice standard baked goods.

The method involves processing an egg protein material comprising egg white, whole egg and/or egg yolk to retain the egg proteins while removing minerals and glucose naturally present in egg. Removing minerals is referred to herein as “deashing.” This deashing process improves the final egg product's flavor. Deflavored egg protein isolate has less egg flavor, is less salty, and is more bland than dried egg.

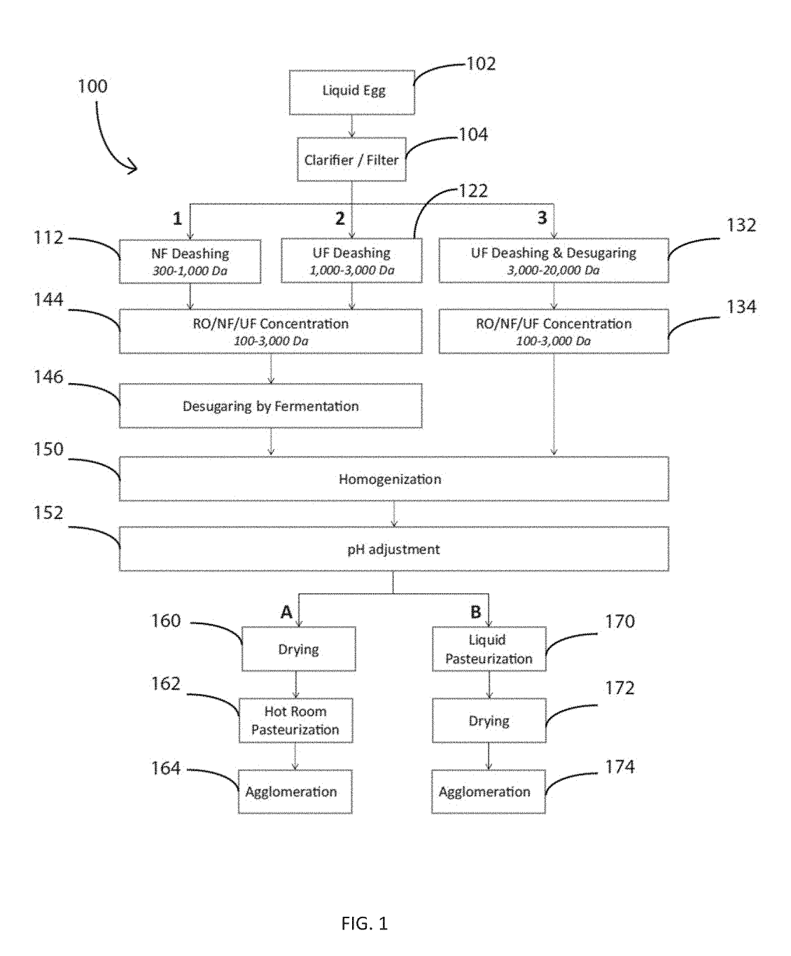

Higher levels of deashing may be achieved if ultra-filtration and/or nanofiltration is performed with diafiltration. The diafiltration may be either continuous diafiltration (constant volume diafiltration) or discontinuous diafiltration. In some examples, the method is performed between 0.5-7 diafiltration volumes. In some examples, the method is performed between 4-6 diafiltration volumes. The process includes, in example embodiments, the steps outlined in FIG. 1.

In addition, the product may be pH adjusted and homogenized during processing prior to drying to optimize solubility, gelling, and heat stability characteristics in final food products such as beverages. Protein isolates are traditionally defined as products with greater than or equal to 90% protein on a dry basis. Standard dried egg whites normally contain 84-88% protein dry basis.

Standard dried egg whites are typically produced by concentrating raw liquid egg whites removing approximately 50% of water, such as by reverse osmosis (RO). Subsequently the concentrated product is desugared by fermentation with yeast or use of enzymes like glucose oxidase and pH adjusted prior to spray drying. Reverse osmosis systems allow water removal from the product with minimal mineral loss; this ensures the final dried egg white is nutritionally equivalent to the starting material.

Deflavored egg protein isolate is a dried protein product containing a minimum 92% dry basis protein (minimum 85% as is protein or 85% per 100 g powder). The flavor of this product is often significantly more neutral than standard dried or liquid egg products (e.g. bland flavor, less salty, less eggy notes). In addition, the final powder may have higher heat stability, that is, a higher coagulation temperature, allowing for better use in beverage processing where ultra-high temperature (UHT) or high-temperature-short-time (HTST) processes are typically used.

Deashing technologies can be used to produce egg protein isolates with a higher protein dry basis. Deashing also deflavors the egg product which is a highly desirable characteristic in food and health & nutrition products such as beverages and protein bars.

Various aspects of the egg protein isolate and process for making it will now be referenced in the figures. FIG. 1 shows a flow chart for an example method 100 for making an egg protein isolate. The method begins at step 102, in which liquid egg is provided. The starting raw material used in this process can be, for example, raw, unpasteurized liquid egg or heat treated (such as pasteurized) liquid egg with product solids typically from 10-14%, more typically from 11.5-12.5%. At step 104, the liquid egg is put through an optional clarifier or filter.

After the initial optional clarifier or filtering step, the egg material is deashed. In some implementations, the method includes deashing the egg material using ultrafiltration (UF) or nanofiltration (NF) technologies. In some implementations, deashing removes 45-100% of minerals. In alternative examples, deashing removes 50-80% of minerals. In some examples, the deashing removes greater than 45% or greater than 50% of minerals. In some examples, deashing removes less than 100% or less than 80% of minerals.

In a first example of the technology, the liquid egg material, in this case, liquid egg white, is deashed using nanofiltration in step 112. The nanofiltration membrane may have a molecular weight cutoff of between 300-1,000 Da. In a second example of the technology, the liquid egg is deashed at step 122 using ultrafiltration with an ultrafiltration membrane having a molecular weight cutoff of between 1,000-3,000 Da. In a third example of the technology, the filtered liquid egg is deashed and desugared in one step, step 132, using an ultrafiltration membrane having a molecular weight cutoff of between 3,000-20,000 Da.

In some implementations, specific molecular weight cut-offs for the membrane used for deashing are between 300-20,000 Da. The use of ultrafiltration membranes with a molecular weight cutoff of about 5,000 Da or less minimizes protein loss in the permeate. In alternative examples, the molecular weight cut-offs are between 300-20,000 Da; 800-20,000 Da; 1,000-20,000 Da; 3,000-20,000 Da; 5,000-20,000 Da; 10,000-20,000 Da; 300-10,000 Da; 800-10,000 Da; 3,000-10,000 Da; 5,000-10,000 Da; 300-5,000 Da; 800-5,000 Da; 1,000-5,000 Da; 3,000-5,000 Da; 300-3,000 Da; 800-3,000 Da; 1,000-3,000 Da; 300-1,000 Da; or 800-1,000 Da. Alternatively the molecular weight cut-offs are greater than 300 Da, greater than 800 Da, greater than 1,000 Da, or greater than 3,000 Da. In some examples, the molecular weight cut-offs are less than 20,000 Da, less than 10,000 Da, less than 5,000 Da, less than 3,000 Da, or less than 1,000 Da.

The example process that proceeds to step 132, in which the egg is deashed and desugared simultaneously, desugaring can be achieved during the ultrafiltration step 132 by using filtration elements with molecular weight cutoffs between 3,000-20,000 Da.

During deashing in either step 112 or step 122 or step 132, an initial preconcentration treatment to increase the solid content to up to 24% solids can help remove some sugars and salts upfront, which may reduce the amount of water needed for diafiltration, discussed below. After the liquid egg is deashed in either step 112 or step 122 or step 132, the resulting product is concentrated at step 134 or 144. The concentration steps 134, 144 may be performed using reverse osmosis, nanofiltration, or ultrafiltration. Membrane filtration using reverse osmosis, nanofiltration or ultrafiltration prior to drying improves overall efficiency when the egg protein isolate is dried. In some examples, reverse osmosis, nanofiltration, or very low ultrafiltration is performed with a membrane having a molecular weight cutoff of between 100-3,000 Da. Concentrating egg proteins using higher than 3,000 Da membranes can be technically challenging and may lead to considerable protein losses due to the size and shape of egg proteins.

Concentration by evaporation is not recommended for egg because evaporation requires the use of heat. This causes foaming, gelling, or coagulation of the egg.

At step 146, the concentrated egg product of the first and second examples of the technology, which was either deashed in step 112 by nanofiltration or deashed in step 122 by ultrafiltration, is desugared. Desugaring at step 146 can be achieved using yeast fermentation or enzymatic reactions using enzymes like glucose oxidase. Removing sugars from the concentrated egg product can help minimize Maillard reaction browning of the egg protein isolate during subsequent steps such as drying and storage. Desugaring desirably leads to increased blandness of the final egg isolate product.

After the desugaring and concentration steps, at step 150 the egg product is homogenized. Homogenization is an optional process that can be used to reduce viscosity and particle size, and improve overall protein dispersability, particularly when the starting material is raw liquid.

At step 152, the pH of the concentrated, desugared egg product is adjusted. This pH adjustment is an optional process to control protein solubility based on protein isoelectric point. The pH adjustment step 152 ensures that the pH of the finished powder is within specification. The pH can be adjusted to neutral range (e.g., between 6-8) which makes the finished egg protein isolate product more suitable for use in baked goods and neutral or low-acid beverages. Alternatively, the pH can be adjusted to an acidified range (e.g., between 3-5) which makes the egg protein isolate product more suitable for high-acid beverage applications, particularly ready-to-drink beverages.

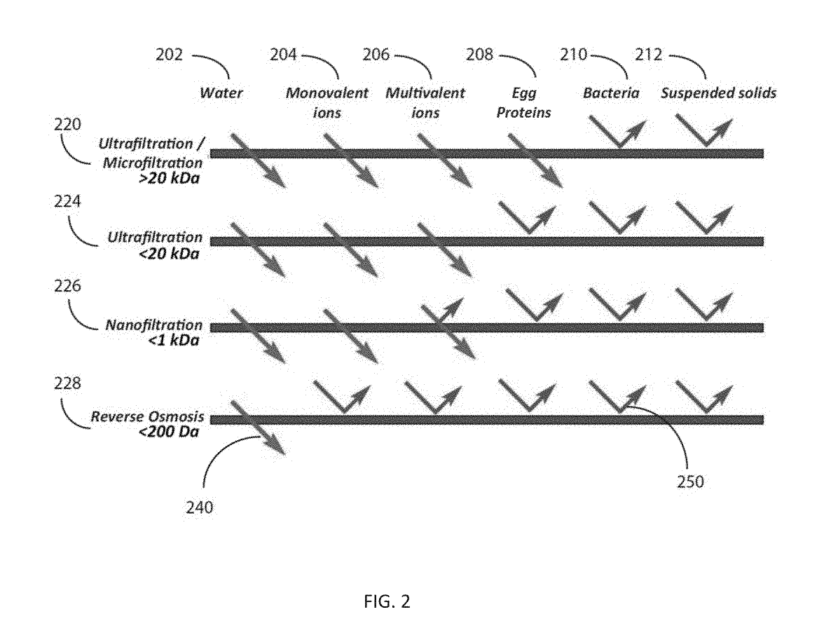

FIG. 2 is a conceptual diagram showing the response of different molecules to different types of filtration. In the diagram, the arrows 240 represent a molecule passing through a membrane or filter, and the arrows 250 represent a molecule not passing through a filter. The filtration processes of interest are ultrafiltration (or microfiltration), occurring at a molecular weight cutoff of greater than 20 kDa (20,000 Da); ultrafiltration at molecular weight cutoffs of less than 20 kDa and greater than 1 kDa; nanofiltration at less than 1 kDa, and reverse osmosis, which has a molecular weight cutoff of less than 200 Da.

As shown in FIG. 2, water 202 will pass through microfiltration, ultrafiltration, nanofiltration, and reverse osmosis filters. Alternative membrane filtration systems such as nanofiltration (NF) and ultrafiltration (UF) can be used to remove not only water but also to demineralize the product, which can help increase the percent of protein in the finished dried product. Microfiltration, ultrafiltration, nanofiltration, and reverse osmosis will each remove bacteria 210 and suspended solids 212 from the liquid egg mixture. Egg proteins 208 can be effectively filtered out using ultrafiltration 224 below 20 kDa, or nanofiltration 226 below one kDa, or using reverse osmosis 228. Egg proteins 208 will pass through a microfiltration or ultrafiltration membrane 220 greater than 20 kDa. Monovalent ions 204 will not pass through a reverse osmosis filter, but will pass through a nanofiltration, ultrafiltration, or microfiltration membrane. Multivalent ions 206 will not pass through a reverse osmosis membrane 228, but will pass through ultrafiltration or microfiltration membranes 220, 224. In the nanofiltration range below 1 kDa, some multivalent ions may pass through the membrane, but some will be filtered out.

Egg protein isolates can be produced using nanofiltration membranes with molecular weight cutoffs less than or equal to 1,000 Da; ultrafiltration membranes with molecular weight cutoffs less than 3,000 Da; or ultrafiltration membranes with molecular weight cutoffs between 3,000-20,000 Da.

Successful protein demineralization depends upon use of filtration membranes with the right molecular weight cutoff to remove water and small non-protein species (i.e., sodium ions, salts, divalent/monovalent ions, flavonoids, sugars, etc.) without losing proteins or small protein peptides in the permeate stream. For example, most of the proteins in egg whites have a molecular size between about 14-85 kDa. Due to the broad size and shape range of egg proteins, filtration membranes sometimes require feed spacers of greater or equal to 46 mil.

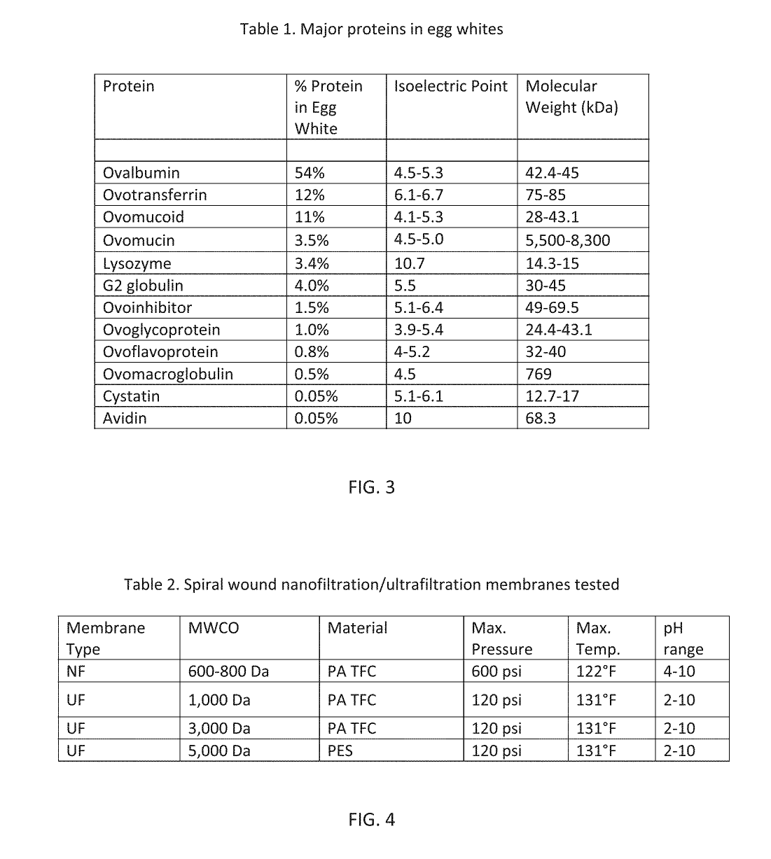

FIG. 3 is a table listing the proteins found in egg whites, along with the isoelectric point and molecular weights of each type of protein. Notably, the proteins in egg whites vary greatly, with the smallest protein, cystatin, having a molecular weight of about 12.7 kDa, and the largest protein, ovomucin, having a molecular weight of as much as 8,300 kDa. The three proteins that make up about 77% of the total amount of protein in egg whites—ovalbumin, ovotransferrin, and ovomucoid—have molecular weights between about 28-85 kDa. These three proteins have a globular shape. They have a broad range of isoelectric points—between about 4 and about 7. Overall, the proteins in egg whites have isoelectric points as low as 3.9, and as high as 10.7.

Filtration across a filtration membrane is performed under pressure. Nanofiltration deashing at step 112 allows for the use of relatively higher pressures compared with ultrafiltration at step 122 or ultrafiltration at step 132. Nanofiltration is typically performed at a pressure less than 600 pounds per square inch (psi), and preferably between 300-350 psi. Ultrafiltration and microfiltration require lower pressures, typically below 150 psi, and preferably between 30-60 psi.

The deashing process may be more efficient if performed with diafiltration. The diafiltration can be either continuous or discontinuous, using (for example) between 0.5-7 diafiltration volumes. Diafiltration is preferably at 4-6 diafiltration volumes. This significant amount of water is needed to achieve the necessary amount of desugaring of the egg whites.

Diafiltration is optional, but it is an effective processing step to maximize removal of sugars and minerals. Diafiltration is more efficient if performed at less than 17% solids to minimize membrane fouling and maximize permeate flow rates. Also, if water usage is of concern, pre-concentrating the egg prior to diafiltration will help remove a significant amount of sugars and minerals up front, increasing egg solids from 11-12% to 17-24%. The maximum percentage of solids achieved by filtration are typically about 26%, but the percentage can be as high as 35-40%.

After deashing and desugaring, with or without homogenization and pH adjustment, the liquid egg product can go into a second stage process, in which the deashed and desugared egg protein material can be pasteurized or heat treated and/or dried. The second stage can be performed in various ways. In a first example of the technology at the second stage, the concentrated egg product is dried into a powder at step 160, referring to FIG. 1. The dried powder is then packed and optionally pasteurized/heat treated in powder form inside a hot room at step 162. This step is typically necessary to meet USDA lethality requirements. As will be discussed later, the dried, powdered egg white protein isolate product in this case retains some whipping characteristics, but still has improved characteristics over standard dried egg whites. After pasteurization/heat treatment at step 162, the dried egg white isolate product can go through an additional agglomeration process to instantize the product at step 164. The agglomeration step 164 is optional, however, agglomeration makes the egg white isolate product instantly soluble in water, which is desirable for a number of applications. Optionally, instantizing the egg white isolate powder can include encapsulation with lecithin. Encapsulation improves the dispersability of the powder in water and prevents breakage of the agglomerated particles during transportation and shelf life. Instant dispersability is useful when the egg white protein isolate product is used in dry beverage blends.

In a second example of the technology at the second stage, after demineralization and desugaring (with or without homogenization and pH adjustment), the product is first pasteurized or heat treated in liquid form at step 170. This process eliminates the need for hot room pasteurization/heat treatment of the material in powder form. This pasteurization/heat treatment of the liquid is used particularly when the original product provided at step 102 is raw/unpasteurized liquid egg. Liquid pasteurization/heat treatment at step 170 can be optional if the starting material at step 102 is pasteurized liquid egg.

Pasteurizing or heat treating a concentrated liquid egg protein isolate with high solids can be challenging because there are limitations on temperatures and holding times that can be used to reduce microbial load without resulting in protein denaturation and coagulation. In some examples, heat treatment includes pasteurization for a time limit up to 2 hours at a temperature less than 54° C. (129.2° F.); or alternatively 1-5 minutes at 55-60° C. (133.7-140° F.). Heat treating the liquid egg white protein concentrate at temperatures above 60° C. (140° F.) prior to drying may lead to protein denaturation and coagulation, especially when the liquid product has a high percentage of solids (for example, greater than 20% solids).

When the egg white protein isolate is pasteurized/heat treated in liquid form at step 170 followed by drying at step 172, the heat stability of the resulting product is generally greater than when the egg product is dried at step 160 followed hot room treatment at step 162. Additionally, when the liquid egg white is first pasteurized at step 170 before the drying step 172, the resulting dried egg white protein isolate product has significantly lower whipping and foaming properties compared to standard dried egg whites; this is a desirable characteristic in some food applications.

After or during drying, the product can go through an additional agglomeration process to instantize the product. Agglomeration is an optional process. By eliminating the use of hot room treatment, this instantization step can be completed during drying using fines recycling in tower dryers or in a fluid bed agglomerator. Encapsulation with lecithin is optional, but recommended for improved dispersability of the powder and to reduce breakage of the agglomerated particles during shelf life. As mentioned above, instant dispersability is useful when the egg white protein isolate product is used in dry beverage blends.

### EXPERIMENTAL

### Pilot and Production Trials

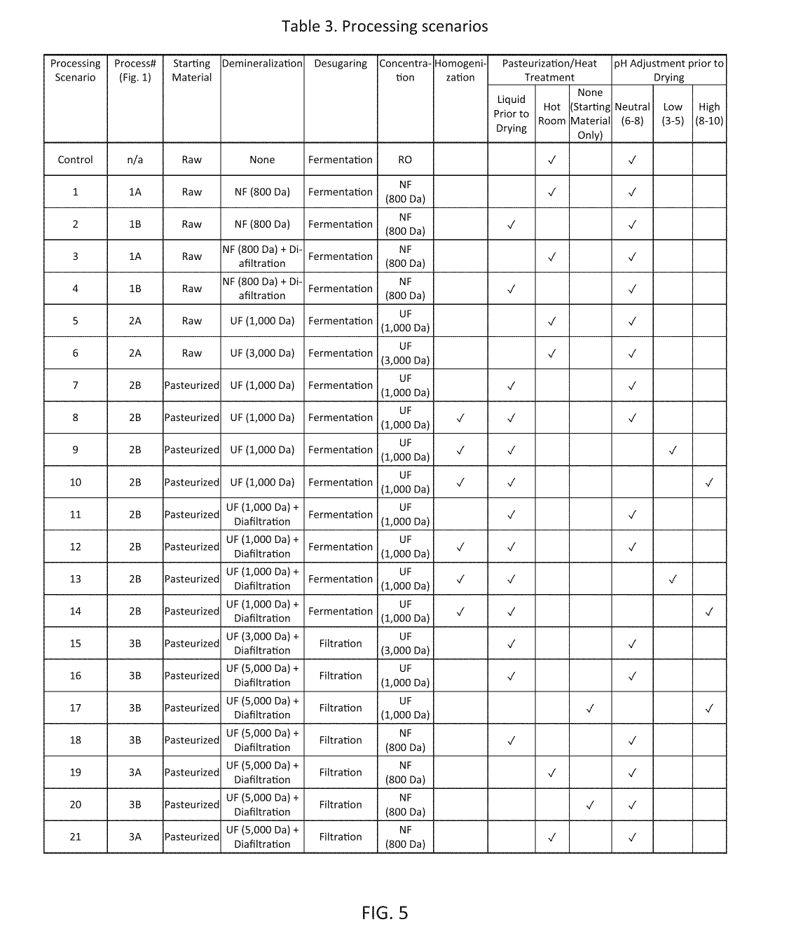

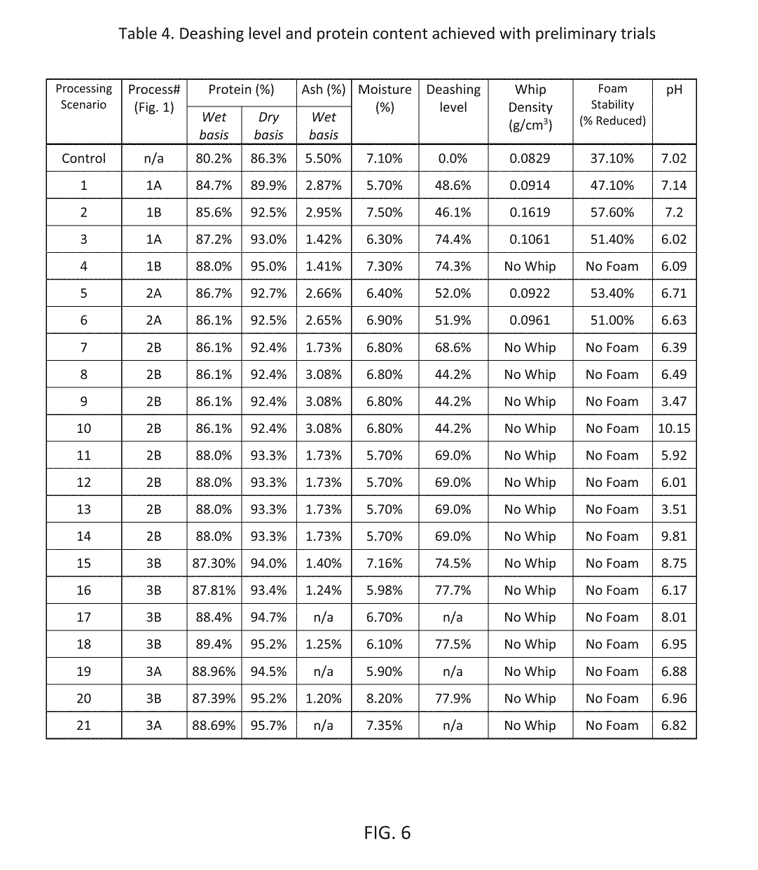

A total of seventeen pilot trials (Processing Scenarios 1-17, detailed in FIG. 5) and one semi-production trial with four variables tested (Processing Scenarios 18-21, detailed in FIG. 5) were conducted. Processes described in relation to FIG. 1 were used in each scenario.

Four different spiral wound UF/NF membranes were tested, as shown in Table 2 of FIG. 4. A nanofiltration (NF) membrane with a molecular weight cutoff (MWCO) of 600-800 Da was tested. The nanofiltration membrane was made of polyamide thin film composite (PA TFC). During filtration, the filter was put under a maximum pressure of 600 pounds per square inch (psi), subjected to a maximum temperature of 122° F., and the pH range was between 4-10. Three ultrafiltration (UF) membranes were also tested. Two ultrafiltration filters were made of polyamide thin film composite (PA TFC) and had a molecular weight cutoff (MWCO) of 1,000 Da and 3,000 Da respectively. One ultrafiltration membrane was made of polyethersulfone (PES) and had a molecular weight cutoff of 5,000 Da. In each case, the ultrafiltration membranes were subjected to a maximum pressure of 120 psi; a maximum temperature of 131° F., and a pH range between 2-10.

“Process 1” refers to the example in which at step 102 raw or pasteurized egg whites are provided; in step 104, the egg whites are optionally filtered; at step 112 the egg product is deashed using nanofiltration between 300-1,000 Da; at step 146 the egg product is desugared; at step 150 the egg product is optionally homogenized; and at step 152 the egg product is optionally pH-adjusted.

“Process 2” refers to the example in which: at step 102 raw or pasteurized egg whites are provided; in step 104, the egg whites are optionally filtered; at step 122 the egg product is deashed using ultrafiltration between 1,000-3,000 Da; at step 144 the egg product is concentrated through filtration with a molecular cutoff between 100-3,000 Da; at step 146 the egg product is desugared; at step 150 the egg product is optionally homogenized; and at step 152 the egg product is optionally pH-adjusted.

“Process 3” refers to the example in which: at step 102 raw or pasteurized egg whites are provided; at step 104, the egg whites are optionally filtered; at step 132 the egg product is both deashed and desugared using ultrafiltration between 3,000-20,000 Da; at step 134 the egg product is concentrated through filtration with a molecular cutoff between 100-3,000 Da; at step 150 the egg product is optionally homogenized; and at step 152 the egg product is optionally pH-adjusted.

“Process A” refers to the example in which a deashed, concentrated egg product created using one of Processes 1, 2, or 3 is put through an additional process in which: at step 160, the egg product is dried; at step 162 the dried egg product is put through hot room pasteurization; and at step 164 the dried egg protein isolate product is optionally agglomerated and optionally instantized.

“Process B” refers to the example in which a deashed, concentrated egg product created using one of Processes 1, 2, or 3 is put through an additional process in which: at step 170, the liquid egg product is pasteurized using liquid pasteurization; at step 172 the pasteurized liquid egg product is dried; and at step 174 the dried egg protein isolate product is optionally agglomerated and optionally instantized.

In turn, the phrase “Process 1A” refers to an example in which liquid egg whites are first put through Process 1, and then put through Process A; “Process 2B” refers to an example in which liquid egg whites are first put through Process 2, and then put through Process B; “Process 3A” refers to an example in which liquid egg whites are first put through Process 3, and then put through Process A, etc.

In the experimental processing scenarios, raw and pasteurized liquid egg whites were converted into dried egg white protein isolates using processes 1A, 1B, 2A, 2B, 3A, and 3B. The control scenario used a process in which raw liquid egg white was first concentrated using reverse osmosis. The concentrated liquid egg white was desugared using yeast fermentation, then pH-adjusted to a neutral pH. The liquid egg white was dried and then heat treated using a hot room pasteurization. The control trial did not undergo deashing or homogenization. Table 3 of FIG. 5 provides additional details regarding the parameters used in each processing scenario.

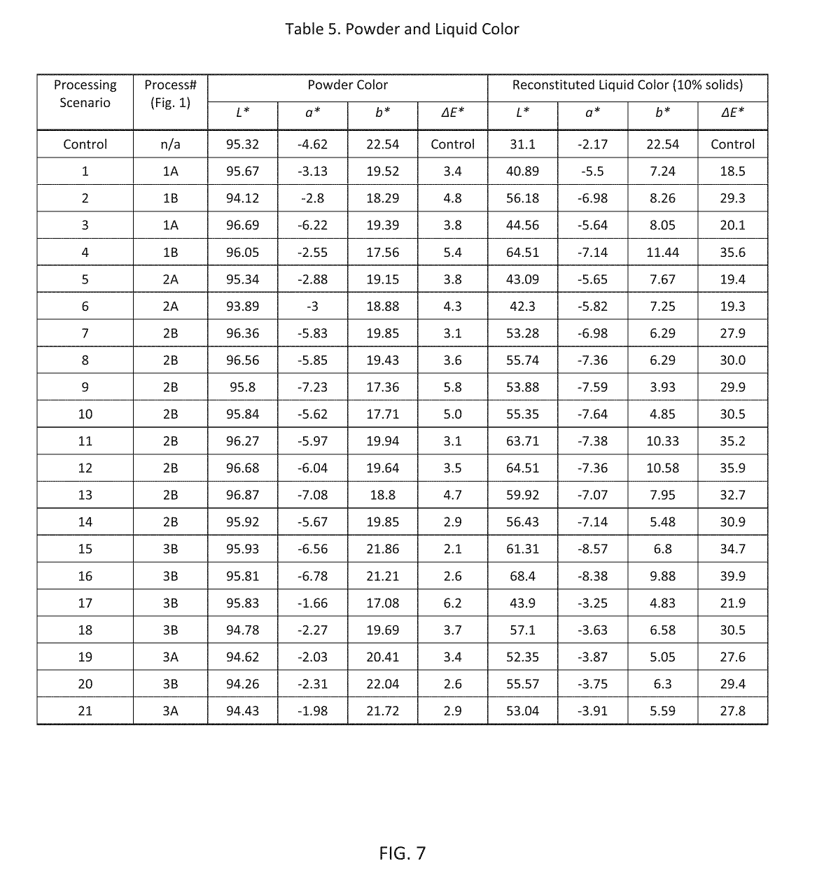

Turning to FIG. 6, deashing levels and protein content of each trial is recorded in Table 4. The maximum protein concentration achieved was 92.7% dry basis without diafiltration (processing scenario 5), and 95.7% dry basis with diafiltration (processing scenario 21). The average deashing level was 50% without diafiltration and 73.2% with diafiltration. Each of the processes 1A, 1B, 2A, 2B, 3A and 3B resulted in dried egg white product with greater than 90% protein dry basis, which therefore could be classified as egg white protein isolate. It is possible to increase protein concentration by adjusting membrane type and processing conditions. For example, the use of diafiltration can result in higher protein concentration, although diafiltration may increase the cost and time of the process.

Process A, which used hot room pasteurization, had slightly lower whipping and foaming characteristics compared to standard egg whites in the control scenario. Conversely, Process B, which used liquid pasteurization and no hot room treatment, either did not foam or resulted in denser foams that fell apart significantly faster than the control. The reduced whipping and foaming properties that resulted from the processes described herein could make the product more suitable for the beverage market. Additionally, mineral removal by deashing resulted in a milder, less salty egg flavor that could make the product suitable for the beverage market. However, the resulting egg white protein isolate product was characterized by poor dispersability, similar to standard egg whites. Thus, for applications in which solubility and dispersability are important, such as in the beverage market, the product may need to be instantized.

Turning to FIG. 7, the color of the powdered egg white protein isolate and a liquid solution of reconstituted egg white protein isolate were measured using a Konica Minolta CR-400 colorimeter. The control dried egg white and a liquid solution of the reconstituted dried egg white was also tested in the same manner.

Color values of the dry and liquid samples were measured. Three readings were taken and averaged for each sample and recorded in Table 5. Specifically, the L*, a*, and b* values were measured. L* is defined as the difference in lightness and darkness of the sample compared to a standard. The L* value of the sample minus the L* value of the standard results in the recorded L* value in Table 5. A higher L* value indicates a relatively lighter color, and a lower

L* value indicates a relatively darker color. The a* value is the difference along the red and green continuum. The a* value of the sample minus the a* value of a standard results in a relative a* value recorded in Table 5, with higher numbers being more red and lower numbers being more green as compared to the standard. The b* value of the sample minus the b* value of a standard results in a relative b* value recorded in Table 5, with higher numbers being more yellow and lower numbers being more blue as compared to the standard.

E* is the total color difference between all three coordinates L*, a*, and b*. To determine the total color difference between all three coordinates, the following formula is used:

ΔE*_{ab}=\sqrt{(L*₂−L*₁)²+(a*₂−a*₁)²+(b*₂*−b*₁)²}

A delta E* value of 0-1 indicates a normally invisible difference. A delta E* of 1-2 indicates a very small difference that is only obvious to a trained eye. A delta E* value of 2-3.5 indicates a medium difference that is also obvious to an untrained eye. A delta E* value of 3.5-5 indicates an obvious difference, and a delta E* value greater than 6 indicates a very obvious difference.

Lighter, less yellow color is a desirable characteristic especially when formulating beverage products. Experimental results found that the dried egg white protein isolate samples prepared according to the methods herein were significantly less yellow and slightly less green than the control dried egg white sample. When the powders were reconstituted with water to 10% solids, delta E* values ranged from 18 to 40 indicating a very significant difference from standard dried egg whites. Reconstituted liquid egg white protein isolate samples were much less yellow (lower b* value) and significantly lighter (higher L* value) than the control sample.

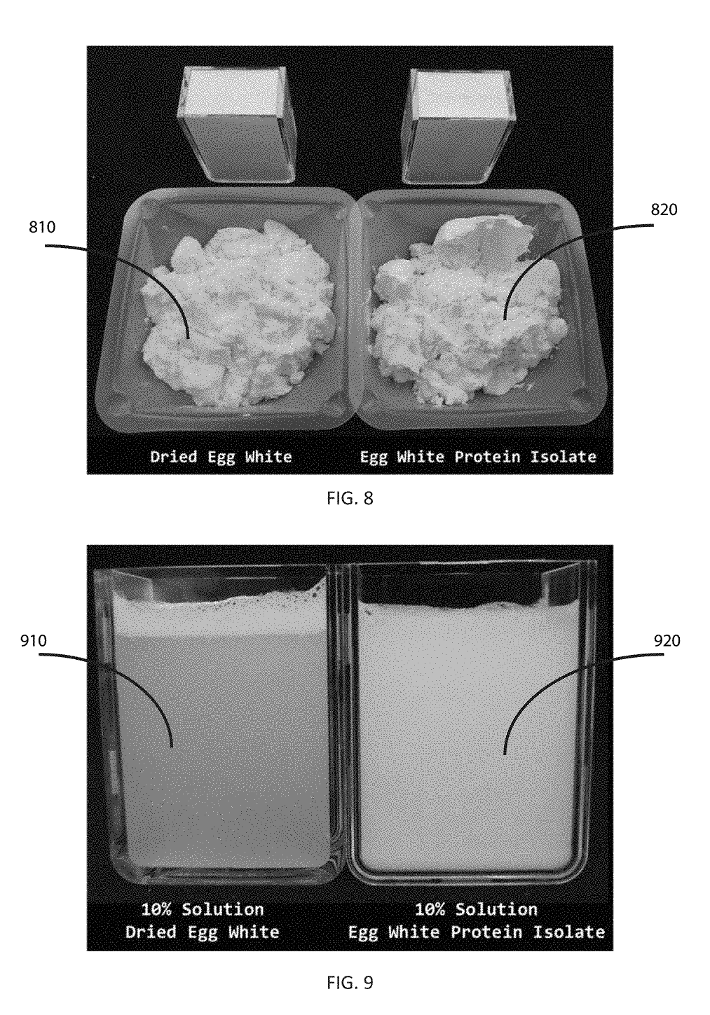

FIG. 8 is a photographic comparison of dried egg white 810 and dried egg white protein isolate 820. FIG. 9 is a photographic comparison of a reconstituted 10% solution of dried egg white 910 and a reconstituted 10% solution of egg white protein isolate 920 prepared according to the teachings herein. The photographic results show that in both dry and liquid form, the egg white protein isolate is considerably whiter compared to standard egg white.

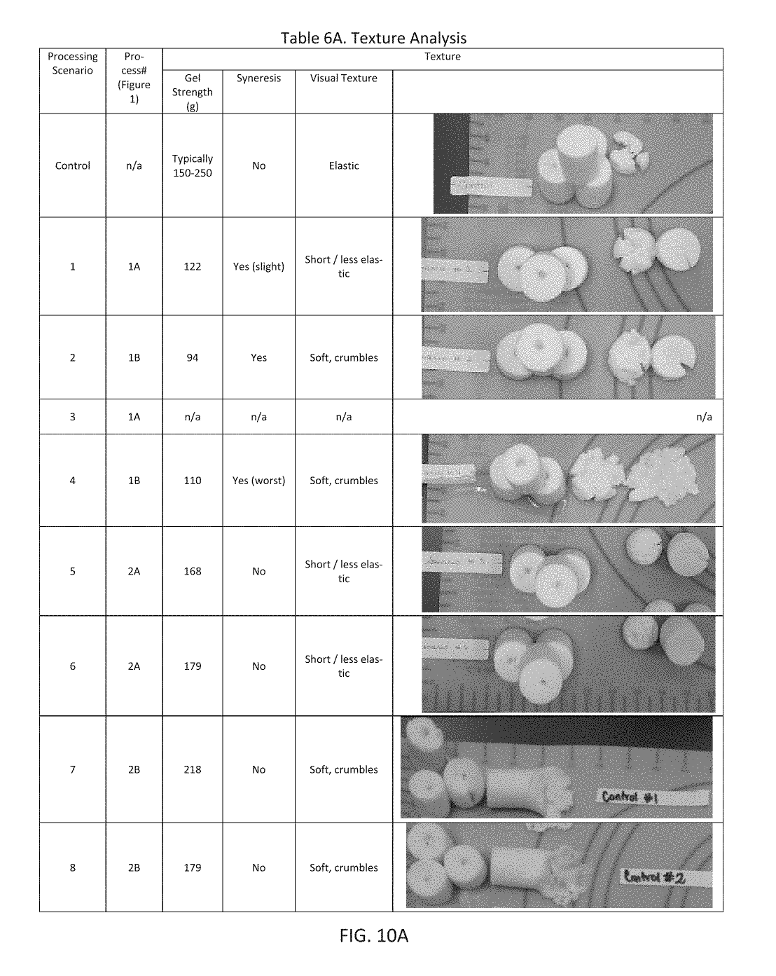

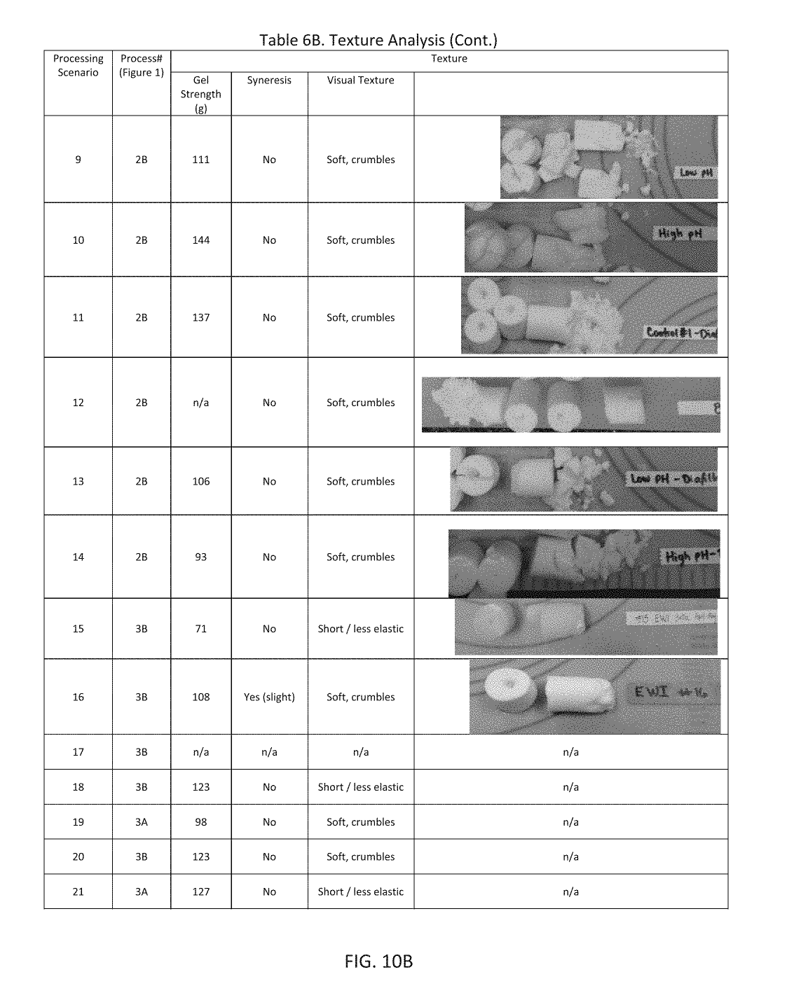

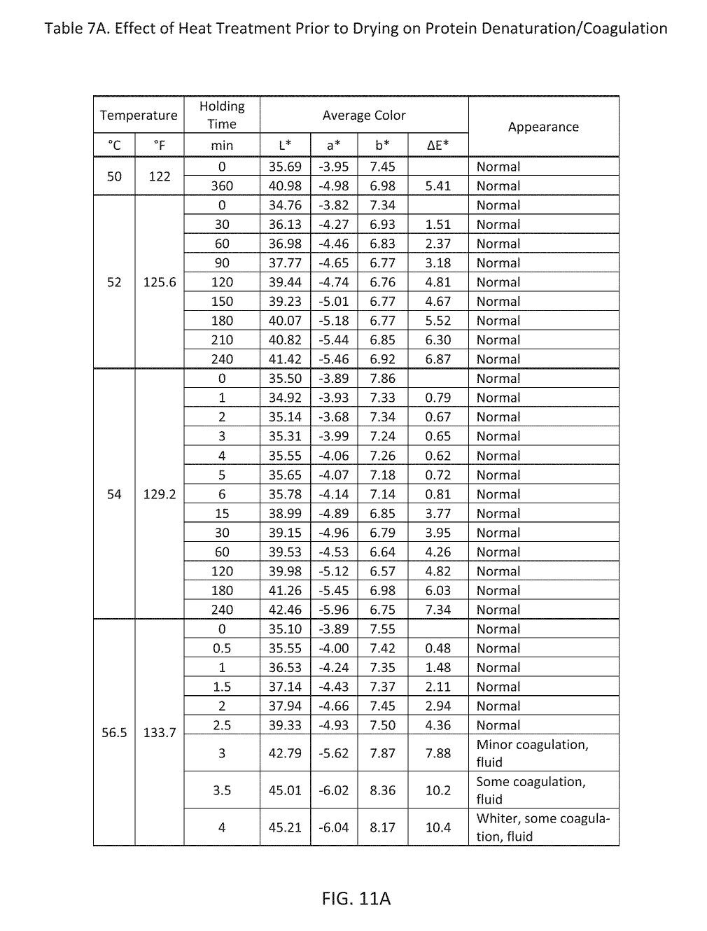

Turning to FIG. 10A-B, a texture and gel strength analysis was performed for each of the samples. The product resulting from Process A had slightly lower gelling characteristics compared to the control sample. The gels formed from egg white protein isolate made using Process A had shorter texture and were less elastic than standard egg whites. Conversely, the product resulting from Process B resulted in significantly less gelling properties and the gels crumbled when pressure was applied. Reduced gelling properties could make the product more suitable for the beverage market: beverages containing egg white protein isolate with reduced gelling may have fewer problems with protein coagulation during pasteurization under UHT or HTST treatment.

### Experimental Results for Process B: Heat Treatment Prior to Drying

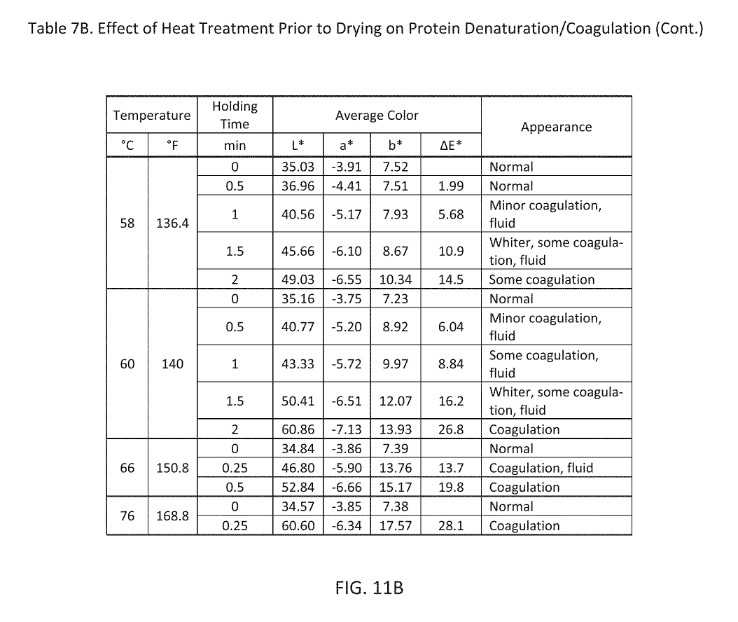

As previously discussed, the pasteurization or heat treatment prior to drying is an optional step if the starting material used for membrane filtration (i.e., demineralization, desugaring, concentration steps) has already received a heat treatment for microbial load reduction (for example, if the starting material is pasteurized liquid egg whites). Process 3 was used to deash/demineralize and desugar liquid egg whites and produce samples of concentrated liquid egg white isolate at 25% solids. Samples were heat treated at different conditions at bench using a water bath and results were validated in a pilot Microthermics Egg Pasteurizer. The goal was to determine optimal temperatures and holding times needed to reduce microbial load during Process B prior to drying. The goal was to prevent protein coagulation and denaturation. Severe protein coagulation can be easily visualized by color and texture changes in the liquid. Thus, color measurements were used to indicate the degree of coagulation and denaturation due to the heat treatment. The results are recorded in Tables 7A and 7B of FIGS. 11A-B. Results indicated that the preferred pasteurization/heat treatment conditions prior to drying include: up to 2 hours of holding time at less than 54° C. (129.2° F.) OR 0-5 min holding time at 55-60° C. (133.7-140° F.). Heat treating the liquid egg white protein isolate at temperatures above 60° C. (140° F.) prior to drying may lead to protein denaturation and coagulation, especially at high solids (i.e., >20% solids).

### Heat Stability of Dried Egg White Protein Isolate

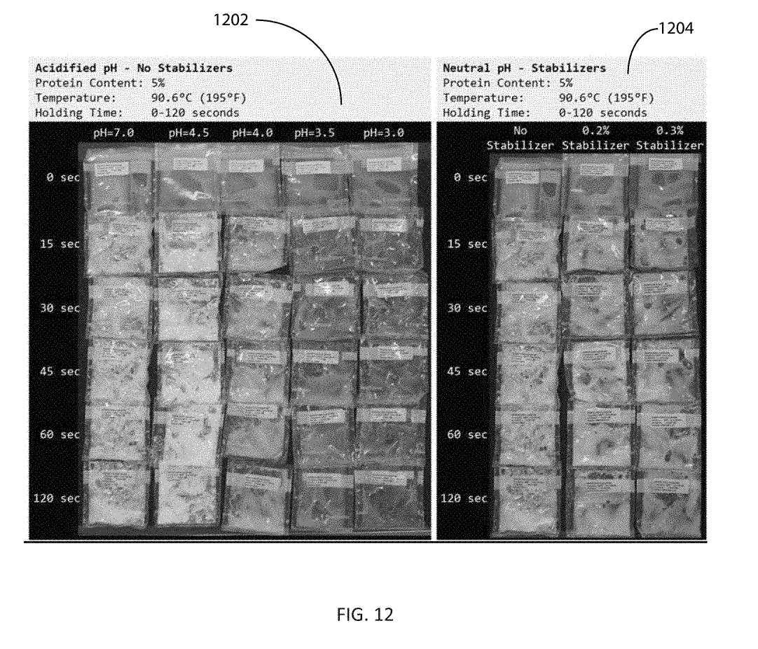

The heat stability of egg white protein isolate samples prepared according to the teachings herein was studied to determine suitability for food applications where heat stability is important, such as in ready-to-drink beverages. Samples of the protein isolate were dissolved in water to target 0-10% protein concentration in the solution. FIG. 12 is a photograph showing the results of this testing. The egg white protein isolate was allowed to hydrate for at least 3 hours. The pH of the solution was adjusted with lactic acid to pH 2-9. Treatments with and without protein stabilizers (e.g., 0.2-0.3% w/w of JOHA B50, JOHA KM2, and BEKAPLUS LS540) were studied. Solutions were packed in 30 g sealed sampling bags and immersed in a water bath at 90.6° C. for 0-120 seconds to simulate typical hot fill pasteurization conditions commonly used for acidified protein beverages. The samples 1202 shown in FIG. 12 were at an acidified pH with no added stabilizers. The samples 1204 in FIG. 12 were at a neutral pH with stabilizers added. The protein content of each of the tests 1202, 1204 was 5%.

As shown in samples 1202 of FIG. 12, 5% protein solutions were still fluid after heating and no visible coagulation was observed at a pH of less than 4.0 without addition of stabilizers. The samples prepared under these conditions were clearer than or as clear as the controls. Thus, the egg white protein isolate can be heat stable at pH below 4.0 without the need for stabilizers.

At a neutral pH, the samples 1204 of the egg white protein isolate did not appear to be heat stable, and coagulation was observed. However, stabilizers can be added to the solution to avoid protein aggregation. The solutions 1204 with added stabilizers changed to a white color after heating, but the resulting solutions were still fluid without visible spots of protein aggregation. The maximum recommended protein inclusion for beverage applications is 5-8% protein concentration (i.e., 5.5-9.5% egg white protein isolate powder). Higher protein inclusions may result in a clearer, non-opaque, gel (acidified pH) or creamy (neutral pH) texture.

It was observed that mild protein coagulation (i.e., some coagulated spots but still fluid after heating) can be reversible by mixing and/or homogenizing the solution after heating. FIG. 12 shows that egg white protein isolate can be heat stable (no protein coagulation) at acidified pH. Stabilizers can be used to achieve heat stability at neutral pH.

### Sensory Analysis of Dried Egg White Protein Isolate

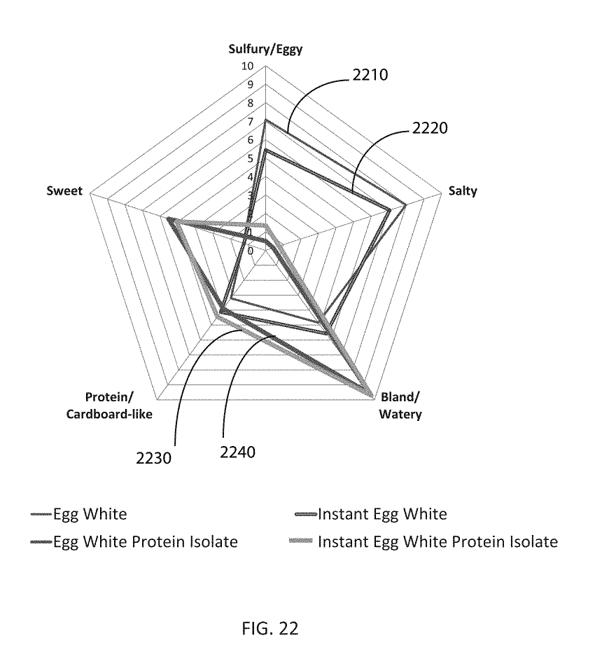

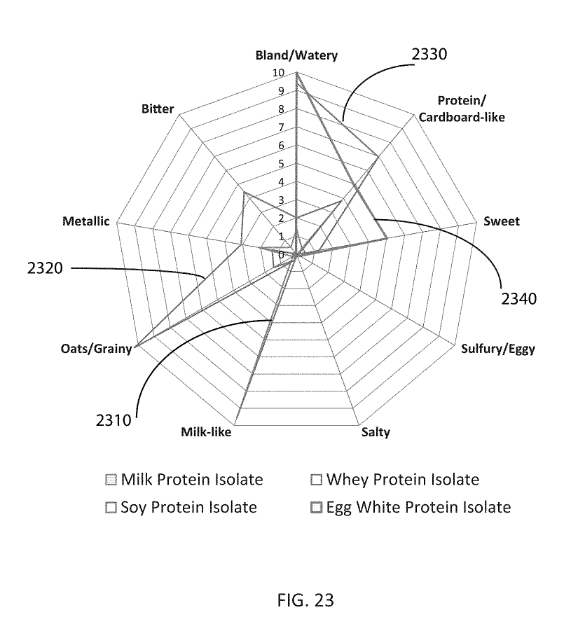

A sensory study was conducted by the Department of Food Science and Human Nutrition of Iowa State University to compare the flavor profile of the egg white protein isolate with standard dried egg white and other protein isolates. A total of 10 trained sensory panelists were used for the study. Blind samples of reconstituted 10% protein solutions were ranked by the trained panel based on different flavor attributes on a 1-15 scale. Three replicates (three different production lots for each product) were evaluated for statistical analysis. Egg white samples were provided by two different suppliers. Samples of competitive proteins were selected from suppliers and brands with the best flavor profile currently in the market: Whey protein isolate (Provon 290 by Glanbia), soy protein isolate (Supro XT by DuPont and ISOPRO 996 SD by Shandong Sinoglory Health Food Co.), and milk protein isolate (MP90 by Milk Specialties). The results of this testing are summarized in FIGS. 22 and 23. FIG. 22 is a spider chart showing the flavor profile of dried egg white vs. egg white protein isolate as described by a trained panel (n=10). The study concluded that the egg white protein isolate has a significantly blander and watery-like flavor with intensified sweetness and lower egg flavor than standard egg whites (p-value>0.05).

FIG. 23 is a spider chart showing the flavor profile of egg white protein isolate vs. other protein isolates as described by the trained panel (n=10). The panel found that egg white protein isolate has a similar flavor profile to whey protein isolate with intensified sweetness and lower metallic and oats/grainy-like notes (p-value>0.05).

Study results agree with observations from previous blind triangle sensory tests conducted at the Rembrandt Foods R&D labs with untrained sensory panelists (n>30). Samples were prepared by dissolving 10 g powder in 90 mL water (10% solution). Three samples were compared:

1. Control: Standard Dried Egg Whites

2. Egg White Protein Isolate Process 3B (Trial #16)

3. Egg White Protein Isolate Process 2B (Trial #12)

Samples were not adjusted for final protein content; therefore the control had 8 g protein and the egg white protein isolate sample contained 8.8 g protein. 100% of the untrained panelists successfully identified the protein isolate sample (Trial #16) in a blind triangle test. 100% of the untrained panelists preferred the isolate over the control sample (standard egg whites). Panelists were asked to rank the sulfury/eggy/salty flavor profile in a 1-5 point scale. Control sample was ranked at 4.7±0.5 egg flavor intensity; whereas the protein isolate was ranked at 1.5±0.6. Typically samples containing higher protein would have more off-flavor, further showing the egg white protein isolate is deflavored.

### Reduced Sodium Beverage Mix

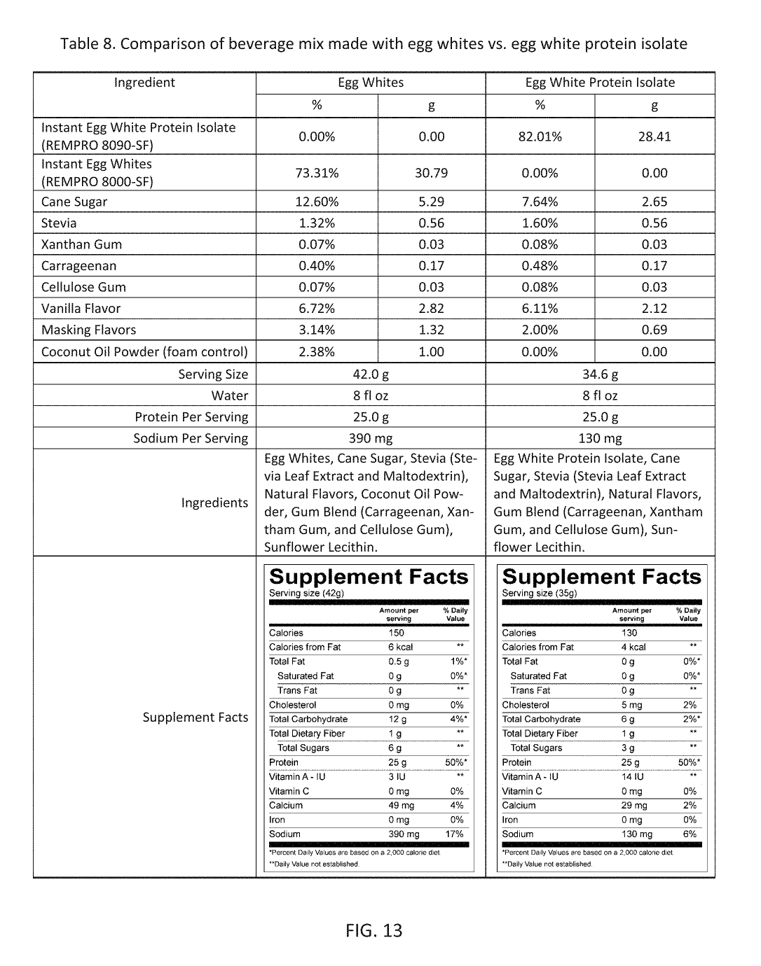

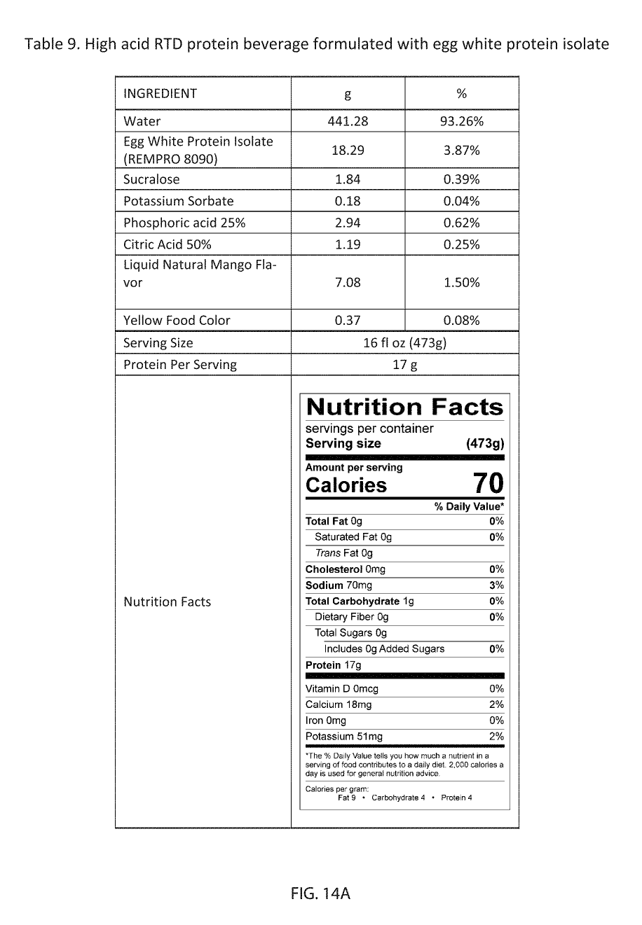

Turning to FIG. 13, formulations of vanilla flavored protein beverage mixes were developed with instant dried egg whites and instantized egg white protein isolate. Table 8 shows a comparison of the ingredients in each mix. The ratio of inclusion of ingredients was adjusted to target the same flavor profile and to provide 25 g of protein per serving. The formulation with egg white protein isolate allowed for a 13% reduction in calories, a 67% reduction in sodium; a 17.5% reduction in serving size; a 7.7% reduction in egg usage to achieve same protein target; a 50% reduction in added sugar; a 25% reduction in vanilla flavor; a 47% reduction in masking flavors; and 100% reduction in foam control agents. Because the egg white protein isolate drink required a smaller amount of each ingredient compared to dried egg whites, the egg white protein isolate beverage mix would have an overall lower cost per serving. The reduction in ingredient amount may also potentially reduce the amount of packaging needed.

### High Acid Ready-to-Drink Protein Beverage

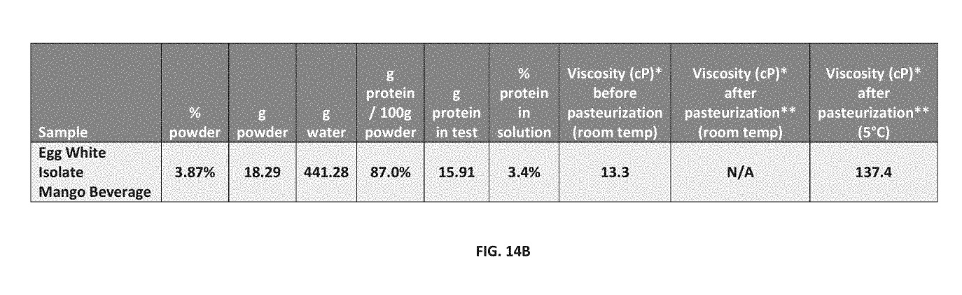

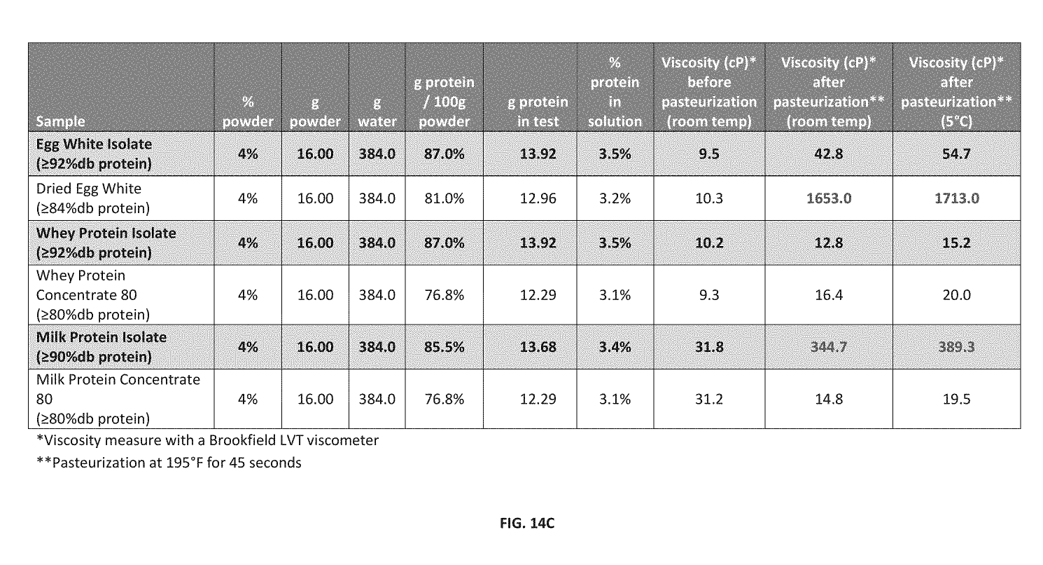

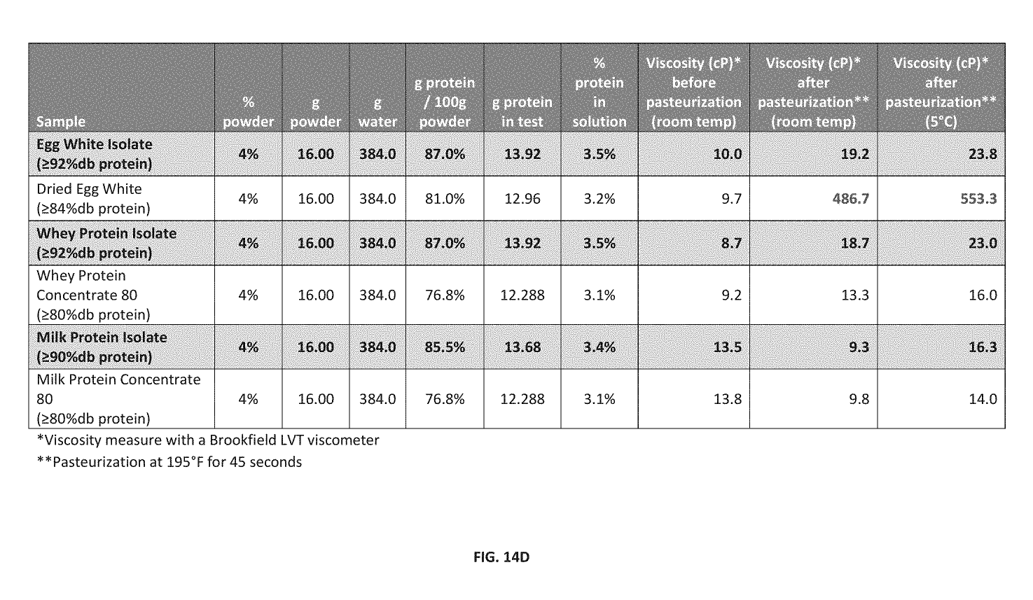

Turning to FIG. 14A, a high acid protein beverage was formulated with egg white protein isolate. Table 9 of FIG. 14A shows the ingredients included in the beverage. The target protein content was 3.5%, which is equivalent to about 4.0% egg white isolate powder. Dry ingredients were mixed and then dissolved in water. The protein was allowed to hydrate for 1 hour. Flavors, colors, and preservatives were then added. The pH was adjusted to 3.75 with 25% phosphoric acid, and further adjusted to pH 3.5 with 50% citric acid for flavor. The beverage was pasteurized under hot fill conditions (195° F. for 45 seconds) and immediately immersed in ice-water mix for cooling.

The viscosity of the beverage before and after pasteurization was measured using a Brookfield LVT viscometer, spindle 1 and speed 60 rpm at 5° C. The sample size was set to 400 grams. The viscosity readings before and after pasteurization were 13.27 and 137.37 cP, respectively. Although there was an increase in viscosity, the beverage remained liquid and no visible indicators of protein coagulation were observed. Thus, egg white protein isolate can be used in high acid protein beverages and exposed to typical hot fill pasteurization conditions without severe protein coagulation.

FIG. 14B shows the viscosity of the beverage of FIG. 14A, having a viscosity after pasteurization of 137.4 cP. FIG. 14C and 14D show viscosities of protein solutions with (FIG. 14C) and without (FIG. 14D) pH adjustment. Viscosity before and after pasteurization at room temp was measured as well as after pasteurization at refrigerated temperatures. For these two formulations 4 percent powder protein solutions were mixed with water and allowed to hydrate for 1 hour. The formulation for FIG. 14C had its pH adjusted to 3.5 with phosphoric acid as this is a typical pH for acidic beverages. The viscosity was measured at room temperature before pasteurization, the mixture was then pasteurized at 195° F. for 45 seconds, then cooled in an ice bath, and viscosity again measured at room temperature as well as 5° C.

Egg white isolate was less viscous than milk protein isolate (MPI) and milk protein concentrate (MPC) prior to pasteurization and similar in viscosity to dried egg white, whey protein isolate (WPI) and whey protein concentrate (WPC). Egg white isolate was less viscous than MPI and dried egg white and slightly more viscous than WPI, WPC, and MPC after pasteurization but fluid like milk. Dried egg white after pasteurization had high viscosity (1500-2000 cP) with a texture similar to a yogurt. Egg white isolate at neutral pH required homogenization after pasteurization. At neutral pH all samples had low viscosity except dried egg white. Dried egg white viscosity at neutral pH was similar to MPI at acidic pH.

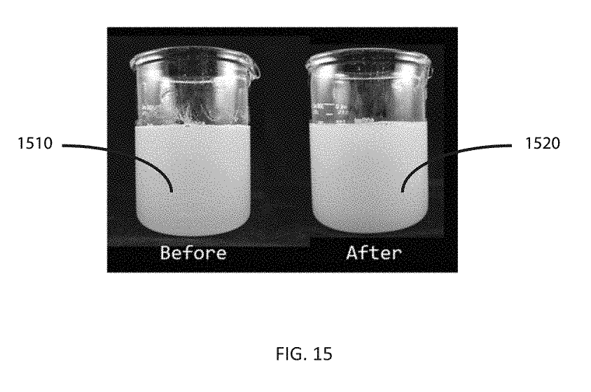

FIG. 15 is a photographic comparison of the beverage form FIG. 14A before and after hot fill pasteurization.

FIG. 14A-D and FIG. 15, illustrate that the egg isolate produced in this disclosure can be used in high acid or neutral protein beverages and exposed to typical hot fill pasteurization conditions without severe protein coagulation at protein concentrations of at least 3.5%. Under neutral pH conditions, it is recommended to use stabilizers and/or phosphates to help with protein stabilization and it is recommended to homogenize the beverage after pasteurization.

### High Protein Bakery Goods

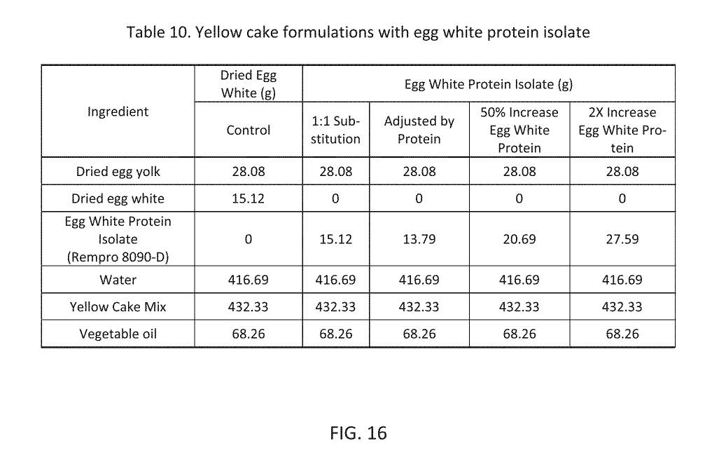

Turning to FIGS. 16-19, samples of egg white protein isolates were used as a substitute for dried egg white in different bakery applications including yellow cakes, muffins, cookies, pancakes, crepes, blintzes, waffles, and other baked goods. Different levels of egg white protein isolate were tested in the formulas, including a 1:1 substitution for egg whites and adjusted usage by protein content. Also, formulations with an additional 50% and two times the original egg white protein content were tested to illustrate application of the product in protein-fortified baked goods.

Examples of formulations with yellow cake were listed in Table 10 of FIG. 16. Dry ingredients were manually blended and mixed with the liquid ingredients in a Kitchenaid mixer with paddle attachment on speed 1 for 15 seconds, then speed 2 for 15 seconds. The bowl was manually scraped to remove accumulation of batter on the sides of the bowl. Then the batter was mixed on speed 5 for 2 more minutes. 600 g of batter was placed into a 9-inch round cake pan lined with parchment paper on the bottom. The cakes were baked for 33 minutes at 350° F. and then removed from the oven and cooled on wire rack.

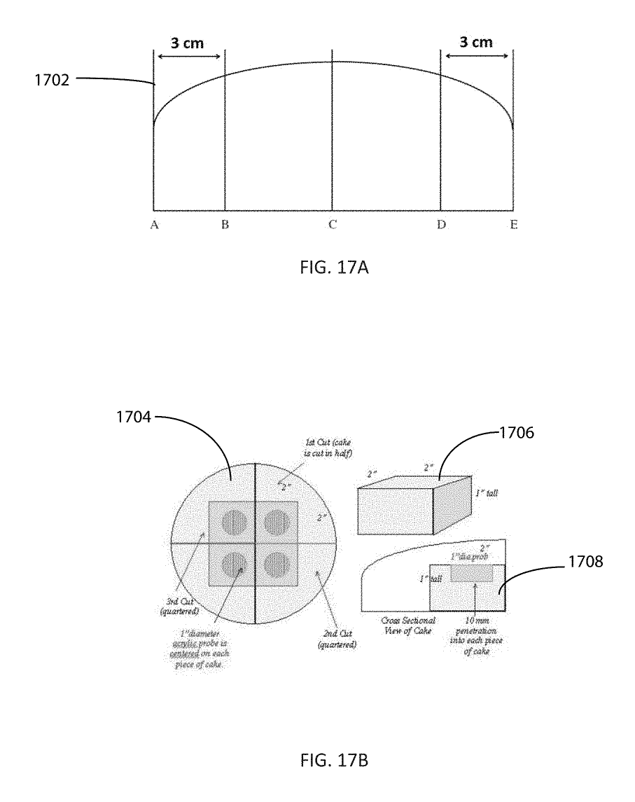

Cake heights were measured according to the AACC international method 10-91.01. This measurement scheme is detailed in FIGS. 17A and 17B. Measurements were used to estimate volume index (B+C+D), symmetry index (2C−B−D) and uniformity index (B−D). Cake hardness, springiness, and gumminess were analyzed following the MB standard method for cake texture analysis. Hardness, cohesiveness, and springiness were measured using a texture analyzer (TA.XTPlus, Texture Technologies Corporation, NY) at 10 mm depth (2 mm/s) and residual hardness after 3 seconds hold time. The probe used for measurement was a 1 inch diameter cylindrical probe (TA-11, acrylic, 35 mm tall) using a 5 kg load cell.

FIG. 17A shows the measurement of cake heights according to AACC 10-91.01. FIG. 17B shows the cake cutting pattern used to obtain samples for texture analysis by Rhodia Corp & Texture Technologies Corp., USA.

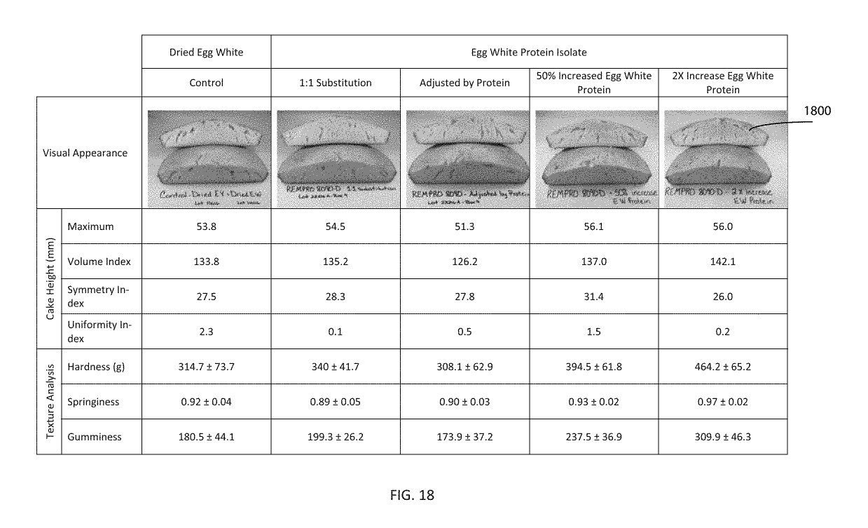

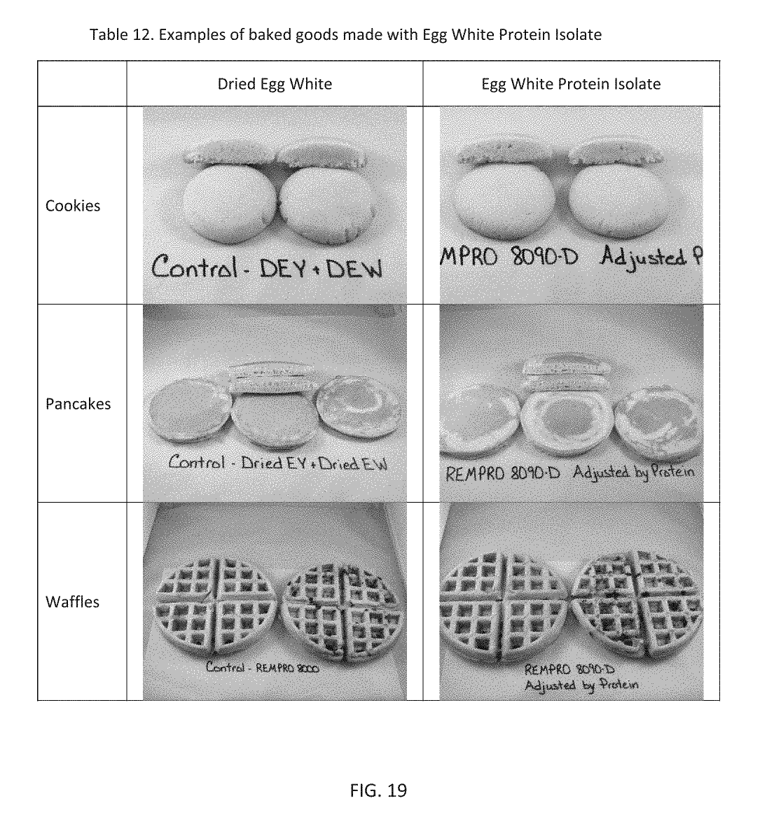

As can be seen in the photographs in the table of FIG. 18, all cakes were similar in appearance. All of the cakes were also similar in taste. Cakes made with the equal (1:1 substitution) or increased amount of egg white protein isolate (50% and 2× increase) had increased volume index and were more uniform in shape than the controls. Cakes with egg whites and egg white protein isolate adjusted by protein content had similar cake height and texture profile. As expected, hardness and gumminess slightly increased with increased protein content, but no significant differences were observed during sensory analysis. However, cakes with 2× protein content had a slightly increased dry mouth feel. Similar results were observed with other bakery applications. FIG. 19 shows photographs of baked goods made with egg white protein isolate compared to baked goods made with dried egg white. In each case, the results were comparable to the controls. Formulas with increased protein content resulted in firmer texture and/or were crispier than the controls.

### Nutrition Bars

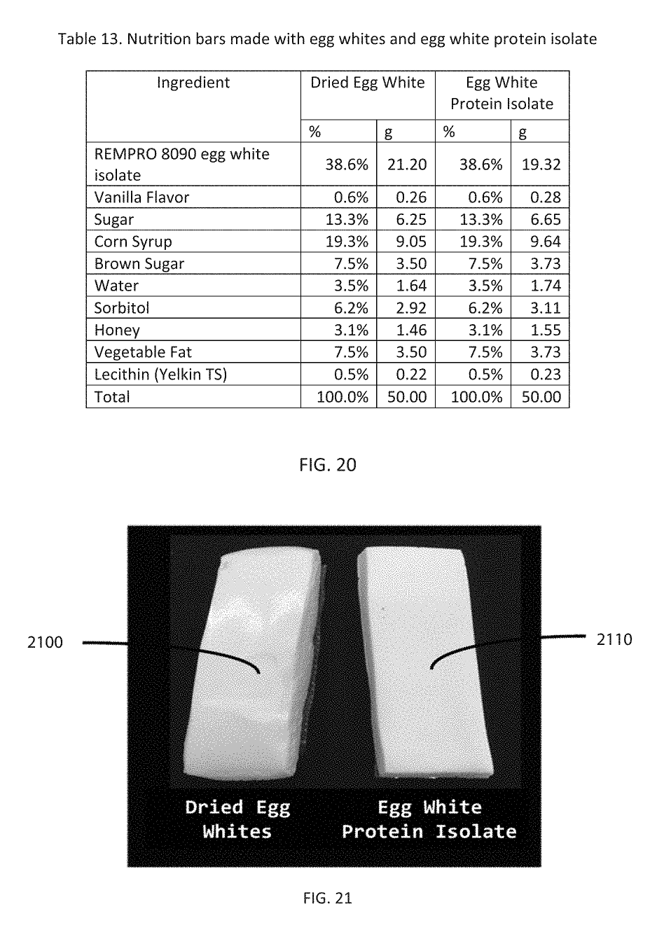

Protein bars were made with egg whites and egg white protein isolate using the formulas presented in Table 13 of FIG. 20. Inclusion of egg white protein isolate was adjusted to match protein content of control formulation with egg whites. Liquid ingredients except vegetable fat and lecithin were mixed manually and boiled to 70% solids. Vegetable fat was added to the boiled syrup. Then egg protein and flavors were dry blended and placed in a Hobart mixer. Warm syrup slurry was slowly poured into the dry mix and the mixture was blended until obtaining a homogeneous dough. The resulting dough was kneaded by hand and rolled to ½″ thickness. The roll was cooled overnight and later cut to the required size (9.5×3.9×1.4 cm). The resulting protein bars with egg white protein isolate were firmer, whiter in color, and experienced less browning during shelf life compared to the control with dried egg white. FIG. 21 is a photographic comparison of the nutrition bar 2100 containing dried egg whites and the nutrition bar 2110 containing egg white protein isolate.

In certain embodiments, this product has the following characteristics:

1. Minimum 92% dry basis protein content

2. Mild/neutral flavor as compared to standard dried egg whites (deflavored product)

3. Less foaming characteristics as compared to standard dried egg whites

4. Better/less color (whiter; less yellow) as compared to standard dried egg whites (dry powder color and as reconstituted liquid)

5. Better heat stability in final product processing as compared to standard dried egg whites (e.g. less coagulation of the egg white proteins; lower gelling characteristics)

6. Egg protein isolates produced using Process B have the added advantages of eliminating lengthy pasteurization by hot room method (7-14 days processing).

7. Egg protein isolates produced using Process B that are instantized have the added processing advantage of eliminating the intermediate packaging step, thus reducing waste.

Use of egg protein isolates instead of standard dried egg whites in final food products can have the following benefits:

1. Increase protein content in finished goods by use of egg protein isolate instead of standard dried egg white (e.g., baked goods, protein bars, protein dry beverage blends and ready-to-drink beverages)

Example:

10 g of egg protein isolate=8.5-9.0 g protein per serving versus

10 g of standard dried egg whites=8.0 g protein per serving

2. Use less amount (%) of egg protein isolate to achieve a specific protein per serving target allowing extra room for additional ingredients as compared to standard dried egg white (e.g., flavors, texture modifiers, other functional ingredients) Example: If a product needs 10 g protein per serving: the product developer would need a maximum of 11.7 g of egg white protein isolate but at least 12.5 g of standard dried egg whites

3. Produce products such as protein beverages or bars with a milder egg flavor

4. Can be used in beverage processing with less need for antifoam ingredient addition.

In some embodiments, the starting material may contain both egg white and egg yolk or may be liquid whole egg material (2400) as shown in FIG. 24. In this option, the liquid egg mixture containing both egg white and egg yolk 2410 is defatted using microfiltration 2420 via U.S. Pat. No. 8,916,156, entitled “ISOLATED EGG PROTEIN AND EGG LIPID MATERIALS, AND METHODS FOR PRODUCING THE SAME” or other methods. The permeate 2450 can then be utilized in the deflavoring processes 2460 outlined in this application. The concentrate 2430 can optionally be dried 2440.

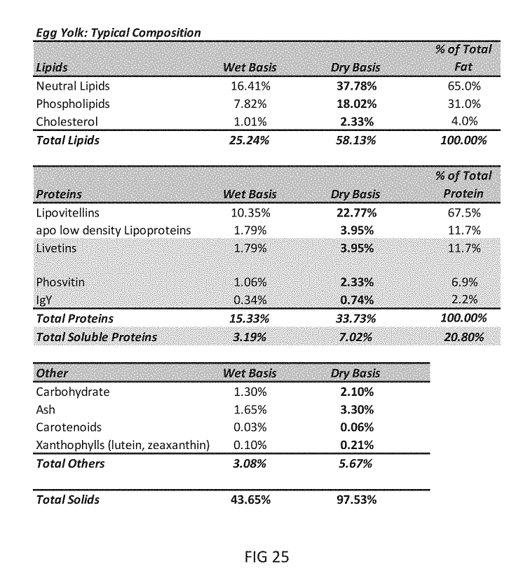

The composition (% egg white protein to % soluble egg yolk protein) will vary depending on the amount of egg yolk to egg white in the starting material. Egg yolk (see FIG. 25) has different proteins than found in egg white (see FIG. 3) and approximately 19 to 23% of the total proteins found in egg yolk are soluble in water. The soluble proteins found in egg yolk include (livetins, Immunoglobulin Y (IgY), and phosvitin).

Phosvitin contains 12% of nitrogen and 10% of phosphorus, and has a molecular weight of 35 kDa (Mecham and Olcott, 1949; Powrie and Nakai, 1986). Phosvitin contains 217 amino acid residues, of which 123 are serine (Byrne et al, 1984). Of the 123 serine residues, 118 are phosphorylated, making it the most highly phosphorylated protein in nature (Byrne et al, 1984; Clark, 1985; Grogan et al, 1990). Due to the large amount of negatively charged phosphoserine residues, phosvitin exhibits strong metal chelating ability, and is believed to provide metal ions during embryonic development (Taborsky, 1983). Phosvitin exhibits numerous other biological properties including antioxidant and anti-bacterial abilities, and excellent emulsion-stabilizing properties (Albright et al, 1984; Chung and Ferrier, 1992; Nakamura et al, 1998; Sattar Khan et al, 2000).

IgY is a key egg immune system protein. IgY antibodies could help to replenish the antibodies depleted by the body. Nonspecific IgY antibodies could be used as a generic supplement ingredient into branded food and beverage products, health products and supplements. For performance athletes, research suggests that your immune system can become weakened through overtraining; thus, adding a product high in IgY could help reduce downtime by replenishing antibodies. In addition to helping balance and support the immune system, other studies have shown that IgY can help maintain digestive-tract health.

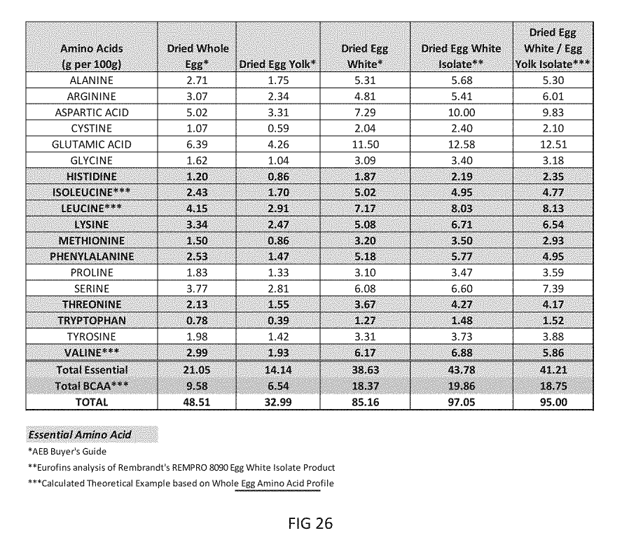

In addition to looking at the types of proteins within egg yolk and egg whites, we can look at the amino acid profile of proteins to determine their nutritional value. FIG. 26 outlines the amino acid composition of dried whole egg, egg yolk, and egg white (source: AEB Buyer's Guide) as well as the Dried Egg Protein Isolate product outlined in this invention (source: Eurofins analytical results). Theoretically, if the product mix starting material included both egg white and egg yolk, the amino acid composition would be more similar to a whole egg-type isolate product (see last column for theoretical calculation). Egg protein isolates are complete proteins (containing all essential amino acids in sufficient quantity to have a PDCAAS score of 1).

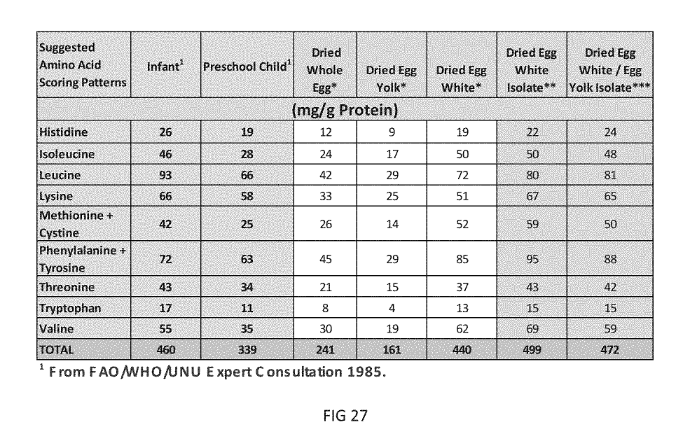

In 1989, a joint FAO/WHO Expert Consultation on Protein Quality Evaluation (FAO/WHO 1990) concluded that protein quality could be assessed adequately by expressing the content of the first limiting essential amino acid of the test protein as a percentage of the content of the same amino acid in a reference pattern of essential amino acids. This reference pattern was based on the essential amino acid requirements of the preschool-age child as published in 1985 (FAO/WHO/UNU 1985). As shown in FIG. 27, the isolates described herein, meet or exceed the needs outlined by the FAO/WHO for preschool aged children.

It should be noted that, as used in this specification and the appended claims, the singular forms “a,” “an,” and “the” include plural references unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

Aspects have been described with reference to various specific and preferred embodiments and techniques. However, it should be understood that many variations and modifications may be made while remaining within the spirit and scope herein.

The embodiments described herein are not intended to be exhaustive or to limit the invention to the precise forms disclosed in the following detailed description. Rather, the embodiments are chosen and described so that others skilled in the art can appreciate and understand the principles and practices.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

We claim:

1. A method of making a deflavored egg protein isolate, the method comprising:
providing liquid egg;
deashing the liquid egg;
concentrating the liquid egg; and
desugaring the liquid egg.

2. The method of claim 1, wherein the liquid egg comprises egg albumen.

3. The method of making a deflavored egg protein isolate of claim 1, wherein the liquid egg comprises albumen and egg yolk.

4. The method of making a deflavored egg protein isolate of claim 1 wherein the deashing step occurs before the concentrating or desugaring step; where the desugaring step occurs before the deashing or concentrating step; or where the concentrating step occurs before the deashing or desugaring step.

5. The method of making a deflavored egg protein isolate of claim 1, wherein one or more of the deashing, concentrating, and desugaring steps are simultaneously performed.

6. The method of claim 1, wherein deashing is accomplished by separation of the minerals from the egg proteins using a nanofiltration or ultrafiltration membrane.

7. The method of claim 1, wherein deashing is accomplished by separation of the minerals from the egg proteins using a membrane of 300 to 1,000 daltons.

8. The method of claim 1 wherein deashing is accomplished by separation of the minerals from the egg proteins using a membrane of greater than 3,000 daltons.

9. The method of claim 1, wherein deashing is accomplished by separation of the minerals from the egg proteins using a membrane of 1,000 to 5,000 daltons.

10. The method of claim 1, wherein deashing is accomplished at a pressure less than 600 psi, preferably less than 150 psi.

11. The method of claim 1, wherein the deashing and desugaring are simultaneous.

12. The method of claim 1, wherein the deashing and desugaring are accomplished simultaneously by separation using a membrane of 3,000 to 20,000 Da.

13. The method of claim 1, wherein removal of the sugars comprises filtration.

14. The method of claim 1, wherein removal of the sugars comprises yeast fermentation or glucose oxidase enzyme reaction.

15. The method of 1, wherein the dried egg product has an ash content below 3 percent.

16. The method of claim 1, wherein the egg product has a gel strength of less than 200 g.

17. The method of claim 1, further comprising diafiltration, wherein the volume of water used is 2 to 6 diafiltration volumes.

18-40. (canceled)

41. A high acid beverage comprising:
water;
egg protein isolate; and
an acid added to the beverage to alter the pH of the beverage.

42-50. (canceled)

51. A method for preparing a high acid beverage, the method comprising:
providing egg protein isolate having at least a 92% dry basis protein content;
hydrating the egg protein isolate in water for between 30 and 90 minutes;
adjusting the pH of the beverage to between 3 and 4; and
pasteurizing the hydrated egg protein isolate under hot fill conditions;
wherein the beverage has no visible indicators of protein coagulation after pasteurization.

52-56. (canceled)
